(19) United States
(12) Patent Application Publication
(10) Pub. No.: US 2026/0252430 A1
(43) Pub. Date: Aug. 27, 2026

(54) DETERMINATION OF ROOT CAUSES FOR INCREASE IN RUNNING COST OF APPLICATION

(71) Applicant: International Business Machines Corporation, Armonk, NY (US)

(72) Inventors: Michele Crudele, Rome (IT); Luca Ioffredo, Pozzuoli (IT); ANDREA INNOCENTI, Rome (IT)

(21) Appl. No.: 19/060,664

(22) Filed: Feb. 22, 2025

(51) Int. Cl. G06F 11/07; G06F 11/30

(52) U.S. Cl. CPC G06F 11/079; G06F 11/302

(57) ABSTRACT

Determination of root causes for increase in running cost of an application includes receiving a set of utilization metrics and a set of billing metrics associated with an application deployed on a cloud platform. Anomaly is detected between the set of utilization metrics and the set of billing metrics based on the set of utilization metrics and the set of billing metrics. A set of changes in at least one of a first application code associated with the application, a first application configuration associated with the application, or a service configuration associated with the cloud platform is detected. A language model is applied to the set of changes. A set of root causes associated with utilization of the one or more resources 208A by the application is determined based on the application of the language model to the set of changes. The set of root causes is outputted.

### BACKGROUND

The disclosure relates to an increase in running cost of an application.

With rapid advancements in the field of technology, there has been a significant increase in the development and deployment of applications across various industries. The applications are typically deployed across various environments, including on-premises servers, data centers, and cloud platforms. However, the deployment of applications on cloud platforms has gained substantial growth due to the advantages of scalability, flexibility, and cost-effectiveness. Cloud services enable organizations to access computing resources on demand, allowing the organizations to scale their operations as per the fluctuating needs of users. The utilization of cloud services enhances the operational efficiency of the organizations as well as reduces the need for substantial initial investments in physical infrastructure such as servers, routers, external hard drives, and the like. Cloud service providers generally employ a consumption-based pricing model in which costs are incurred based on the utilization of the specific resources and services by the application.

### SUMMARY

In various embodiments of the disclosure, a computer-implemented method for determination of root causes for the increase in running cost of an application is described. The computer-implemented method includes receiving, by a computer, a set of utilization metrics associated with an application deployed on a cloud platform. The set of utilization metrics is indicative of a utilization of one or more resources by the application. The computer-implemented method further includes receiving, by the computer, a set of billing metrics associated with the application. The computer-implemented method further includes detecting, by the computer, at least one anomaly between the set of utilization metrics and the set of billing metrics based on the received set of utilization metrics and the received set of billing metrics. The computer-implemented method further includes detecting, by the computer, a set of changes in at least one of a first application code associated with the application, a first application configuration associated with the application, or a service configuration associated with the cloud platform. The set of changes is detected based on the at least one anomaly. The computer-implemented method further includes applying, by the computer, a language model to the detected set of changes. The computer-implemented method further includes determining, by the computer, a set of root causes associated with the utilization of the one or more resources by the application. The set of root causes is determined based on the application of the language model to the detected set of changes. The computer-implemented method further includes outputting, by the computer, the determined set of root causes.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for determination of root causes for the increase in running cost of an application, in accordance with an embodiment of the disclosure;

FIG. 2 is a diagram that illustrates an environment for determination of root causes for the increase in running cost of an application, in accordance with an embodiment of the disclosure;

FIG. 3 is a diagram that illustrates exemplary operations for determination of root causes for the increase in running cost of an application, in accordance with an embodiment of the disclosure;

FIG. 4 is a diagram that illustrates exemplary operations for detection of subset of application code changes in the first application code for determination of first subset of root causes, in accordance with an embodiment of the disclosure;

FIG. 5 is a diagram that illustrates exemplary operations for detection of subset of application configuration changes in the first application configuration for determination of second subset of root causes, in accordance with an embodiment of the disclosure;

FIG. 6 is a diagram that illustrates exemplary operations for detection of subset of service configuration changes in the service configuration for determination of third subset of root causes, in accordance with an embodiment of the disclosure;

FIG. 7A is a diagram that illustrates an exemplary first user interface for determination of root causes for the increase in running cost of an application, in accordance with an embodiment of the disclosure;

FIG. 7B is a diagram that illustrates an exemplary second user interface for determination of root causes for the increase in running cost of an application, in accordance with an embodiment of the disclosure; and

FIG. 8 is a diagram that illustrates a flowchart of an exemplary method for determination of root causes for the increase in running cost of an application, in accordance with an embodiment of the disclosure.

### DETAILED DESCRIPTION

Cloud platforms provide cloud services over the internet, enabling organizations to access shared resources such as servers, storage, and applications on demand. Instead of hosting applications on local servers or devices, the organizations utilize resources from cloud (such as servers, storages, routers, and the like) to run the applications. Cloud services enable easy access through web browsers, offering benefits like scalability, flexibility, and cost savings for the organizations. Cloud service providers manage the infrastructure associated with the cloud services, ensuring that applications are secure and available. The cloud services are based on a consumption-based pricing model that uses a pricing structure in which costs associated with resource consumption are incurred based on the utilization of specific resources and services by the application.

Although the utilization of the consumption-based cloud model is advantageous in many respects for the organizations, the consumption-based cloud model also introduces complexities in financial management for the organizations. With an increase in the utilization of the consumption-based model by organizations, organizations often struggle to analyze and control the costs related to their cloud operations. This challenge in analyzing and controlling the costs leads to unexpected costs that differ from the predicted cost of the organizations based on their utilization of the consumption-based model. The unexpected costs make it difficult for organizations to keep their budgets in check when running applications on cloud services.

One major issue with unexpected costs is associated with the complexities of services, configurations, and usage patterns in the consumption-based model. The above-mentioned complexities make it hard to determine specific reasons for the increase in real-time running costs of the application. Further, the lack of clear cost metrics and analytical tools makes it difficult for organizations to analyze their expenditures in the utilization of cloud services. Therefore, the organizations may find it challenging to identify the root causes of increasing costs, which complicates their ability to manage costs effectively and optimize their cloud usage.

In some instances, when the organizations utilize the cloud services, they often misconfigure the cloud services. For example, the organizations might have unnecessary cloud services running in the background. This misconfiguration leads to excessive resource utilization by applications, resulting in higher operating costs. Often, resources like databases that are set up for applications remain underutilized. This underutilization leads to unnecessary spending, which increases the overall cost of running the application.

The lack of monitoring and alerting mechanisms leads to undetected anomalies in the utilization of the resources by the application. The lack of alerting mechanisms leads to untimely alerts regarding unusual resource consumption patterns during monthly and regular billing statements, leading to complexities in the identification of causes leading to an increase in the running cost of the application.

With possible differences in the billing system of the cloud provider, the billing reports of resource utilization by the application contain numerous discrepancies. These numerous discrepancies lead to anomalies in actual service costs. In some instances, the billing system of the cloud provider is integrated with third-party services (such as external databases) that incur additional costs that are not reflected in the billing statement of the application resource usage. This leads to further differences and anomalies in the cost associated with the usage of the resources by the application.

The disclosed system utilizes correlations (or associations) between the set of utilization metrics indicative of the usage of one or more resources by the application and the set of billing metrics indicative of cost associated with the utilization of the one or more resources by the application. The correlations between the set of utilization metrics and the set of billing metrics help the disclosed system understand the patterns and relationships between the cost associated with the utilization of the resources by the application deployed on the cloud platform and therefore help in detecting the root causes of the increase in the running cost of the application. The running cost of the application is increased due to utilization of the one or more resources by the application. The one or more resources indicate the additional resources utilized by the application which cause the unexpected increase in the running cost of the application. The determined set of root causes is indicative of the possible factors that are responsible for the increase in the running cost of the application. The determined set of root causes also determines the severity of each root cause associated with an increase in the running cost of the application. Therefore, the set of root causes indicates the probable causes of the increase in the running cost of the application. The determination of the set of root causes is utilized to improve the overall resource management of the utilization of the one or more resources by the application. The improved resource management reduces the excess utilization of the computing resources utilized by the computing system. The reduction in the utilization of the computing resources leads to improved processing of operations executed by the computing system, thereby reducing the overall processing time of the computing system and the utilization of the computing resources for running the application deployed on the cloud platform.

The disclosed system determines the set of root causes associated with the utilization of the one or more resources by the application. The one or more resources indicate the additional resources utilized by the application which cause the unexpected increase in the running cost of the application. The disclosed system determines the set of root causes that contribute to an increase in the running cost of the application that is not increased by the increase in the utilization of the application by users. Based on the determination of the set of root causes, the system renders recommendations to alleviate root causes associated with the utilization of the one or more resources by the application. The system utilizes the recommendations to improve the configuration of the application by updating at least one of the application code, application configuration, or service configuration of the application. In an embodiment, the system detects the deployment of a new version of the application in which the application code of the application is updated. The system analyzes the change in the application code by comparing the application code of the current version of the application with the application code of the previous version of the application. The system detects an anomaly in the running cost of the application as the system detects an unexpected increase in the utilization of the computing resources by the current version of the application. For example, the system determines the introduction of a sequential approach by the application to resize a set of images uploaded by a user in the current version of the application which has increased the running cost of the application. The sequential approach is a method of execution in which tasks (say resizing images uploaded by the user) are performed in a linear order such that a second task is initialized upon the completion of a first task. The system determines the root cause indicative of the change in the application code that is associated with the increase in the running cost of the application. Upon the utilization of the sequential approach by the application, the application utilizes 90 percent of the processing capacity of the CPU to resize 100 images in 10 minutes. The system utilizes the recommendation to update the application code of the application. The updated application code implements parallel processing in which multiple images are resized simultaneously by utilizing multi-threading. The multi-threading is indicative of simultaneous execution of multiple threads within a single process. A thread is indicative of a sequence of instructions that can be executed independently on the application (say resizing the image). Upon the update in the application code by the system, the application utilizes 50 percent of the processing capacity of the CPU to resize 100 images in 6 minutes. Further, decreasing the utilization of the one or more resources by the application. The decrease in the utilization of the one or more resources by the application decreases the running cost of the application.

The improvement in the configuration of the application decreases the utilization of the one or more resources by the application. The system updates the application through a plurality of methods, including application code optimization, application configuration optimization, and service configuration optimization to improve the utilization of the one or more resources by the application. The updated application utilizes fewer resources, thereby saving costs in the utilization of the one or more resources by the application. Further, decreasing the overall running cost of the application.

The application code optimization refers to process of updating application code to improve the efficiency, performance, and utilization of the computing resources by the application as compared to the efficiency, performance, and utilization of the computing resources by the application before the application code optimization. For example, the set of root causes indicates the utilization of the one or more resources by the application. The current version of the application utilizes the one or more resources. For example, the previous version of the application stores a user password in three data sources and the current version of the application stores the user password in four data sources. The increase in the count of data sources to store the user password leads to utilization of the one or more resources by the application. In the application code optimization, the developer of the application updates the application code by rolling back to the previous version of the application decreasing the utilization of the one or more resources by the application. Further, decreasing the running cost of the application.

The application configuration optimization refers to process of updating the settings and parameters of the application to improve the efficiency, performance, and utilization of the computing resources by the application as compared to the efficiency, performance, and utilization of the computing resources by the application before the application configuration optimization. For example, the set of root causes indicates the utilization of the one or more resources by the application. The current version of the application utilizes the one or more resources. For example, the previous version of the application utilizes one-step encryption to encrypt the user password and the current version of the application utilizes a two-step encryption to encrypt the user password. The increases in the steps (or layers) of encryption to encrypt the user password leads to utilization of the one or more resources by the application. In the application configuration optimization, the developer of the application updates the application configuration by rolling back to the previous version of the application decreasing the utilization of the one or more resources by the application. Further, decreasing the running cost of the application.

The service configuration optimization refers to the process of updating the settings and parameters of a service associated with the application to improve the efficiency, performance, and utilization of the computing resources by the application as compared to the efficiency, performance, and utilization of the computing resources by the application before the service configuration optimization. For example, the set of root causes indicates the utilization of the one or more resources by the application. The application utilizes a cloud-based storage service to store user data in a standard storage class associated with the cloud-based storage service. The user data includes username, user password, date of birth of the user, language preference of the user, a security question for user account recovery, and billing address of the user. In the current version of the application, the security question for user account recovery is rarely accessed by the application which leads to the utilization of the one or more resources by the application. In the service configuration optimization, the system transfers the rarely accessed user data indicative of the security question for the user account recovery to an infrequent access storage class associated with the cloud-based storage service. The specific change decreases the utilization of the one or more resources by the application. Further, decreasing the running cost of the application.

Based on the improvements in the application by the means of the application code optimization, the application configuration optimization, and the service configuration optimization, an improved application is achieved. The improved application is less prone to errors as the root causes associated with the utilization of the one or more resources are addressed to improve the overall efficiency of the application. The improvement in the application further saves processing time of the application as the application is less cumbersome, as the operations in the application are processed by improved application code, improved application configuration, and improved service configuration.

In various embodiments of the disclosure, a computer-implemented method for determination of root causes for the increase in running cost of an application is described. The computer-implemented method includes receiving, by a computer, a set of utilization metrics associated with an application deployed on a cloud platform. The set of utilization metrics is indicative of a utilization of one or more resources by the application. The computer-implemented method further includes receiving, by the computer, a set of billing metrics associated with the application. The computer-implemented method further includes detecting, by the computer, at least one anomaly between the set of utilization metrics and the set of billing metrics based on the received set of utilization metrics and the received set of billing metrics. The computer-implemented method further includes detecting, by the computer, a set of changes in at least one of a first application code associated with the application, a first application configuration associated with the application, or a service configuration associated with the cloud platform. The set of changes is detected based on the at least one anomaly. The computer-implemented method further includes applying, by the computer, a language model to the detected set of changes. The computer-implemented method further includes determining, by the computer, a set of root causes associated with the utilization of the one or more resources by the application. The set of root causes is determined based on the application of the language model to the detected set of changes. The computer-implemented method further includes outputting, by the computer, the determined set of root causes.

In various embodiments of the disclosure, the computer-implemented method further includes applying, by the computer, a machine learning (ML) model to the set of utilization metrics and the set of billing metrics. The computer-implemented method further includes detecting, by the computer, at least one anomaly based on the application of the ML model to the set of utilization metrics and the set of billing metrics.

In various embodiments of the disclosure, the computer-implemented method further includes determining, by the computer, an application code update of the first application code to a second application code. The computer-implemented method further includes detecting, by the computer, a subset of application code changes in the first application code based on the determination of the application code update. The set of changes includes the subset of application code changes. The computer-implemented method further includes applying, by the computer, the language model to the detected subset of application code changes. The computer-implemented method further includes determining, by the computer, a first subset of root causes of the set of root causes based on the application of the language model to the detected subset of application code changes. The computer-implemented method further includes outputting, by the computer, the first subset of root causes.

In various embodiments of the disclosure, the computer-implemented method further includes comparing, by the computer, the first application code with the second application code. The first application code is associated with a first version of the application and the second application code is associated with a second version of the application. The computer-implemented method further includes detecting, by the computer, the subset of application code changes in the first application code based on the comparison.

In various embodiments of the disclosure, the computer-implemented method further includes determining, by the computer, an application configuration update of the first application configuration to a second application configuration. The computer-implemented method further includes detecting, by the computer, a subset of application configuration changes in the first application configuration based on the determination of the application configuration update. The set of changes includes the subset of application configuration changes. The computer-implemented method further includes applying, by the computer, the language model to the detected subset of application configuration changes. The computer-implemented method further includes determining, by the computer, a second subset of root causes of the set of root causes based on the application of the language model to the detected subset of application configuration changes. The computer-implemented method further includes outputting, by the computer, the second subset of root causes.

In various embodiments of the disclosure, the computer-implemented method further includes comparing, by the computer, the first application configuration with the second application configuration. The first application configuration is associated with a first version of the application and the second application configuration is associated with a second version of the application. The computer-implemented method further includes detecting, by the computer, the subset of application configuration changes in the first application configuration based on the comparison.

In various embodiments of the disclosure, the computer-implemented method further includes detecting, by the computer, a subset of service configuration changes in the service configuration associated with the cloud platform. The set of changes includes the subset of service configuration changes. The computer-implemented method further includes applying, by the computer, the language model to the detected subset of service configuration changes. The computer-implemented method further includes determining, by the computer, a third subset of root causes of the set of root causes based on the application of the language model to the detected subset of service configuration changes. The computer-implemented method further includes outputting, by the computer, the third subset of root causes.

In various embodiments of the disclosure, the computer-implemented method further includes determining, by the computer, a set of scores based on the determined set of root causes. The computer-implemented method further includes associating, by the computer, the set of scores with the determined set of root causes. The computer-implemented method further includes determining, by the computer, a ranked list of root causes based on the association of the set of scores with the determined set of root causes. The computer-implemented method further includes outputting, by the computer, the determined ranked list of root causes.

In various embodiments of the disclosure, the application is associated with one or more services. The determined set of root causes is associated with the utilization of the one or more resources by at least one service of the one or more services.

In various embodiments of the disclosure, a computer system for determination of root causes for the increase in running cost of an application is described. The computer system includes a processor set, one or more computer-readable storage media, and program instructions stored on the one or more computer-readable storage media. The program instructions are executable by the processor set and cause the processor set to receive a set of utilization metrics associated with an application deployed on a cloud platform. The set of utilization metrics is indicative of a utilization of one or more resources by the application. The program instructions further cause the processor set to receive a set of billing metrics associated with the application. The program instructions further cause the processor set to detect at least one anomaly between the set of utilization metrics and the set of billing metrics based on the received set of utilization metrics and the received set of billing metrics. The program instructions further cause the processor set to detect set of changes in at least one of a first application code associated with the application, a first application configuration associated with the application, or a service configuration associated with the cloud platform. The set of changes is detected based on the at least one anomaly. The program instructions further cause the processor set to apply a language model to the detected set of changes. The program instructions further cause the processor set to determine a set of root causes associated with the utilization of the one or more resources by the application. The set of root causes is determined based on the application of the language model to the detected set of changes. The program instructions further cause the processor set to output the determined set of root causes.

In various embodiments of the disclosure, the program instructions further cause the processor set to apply a machine learning (ML) model to the set of utilization metrics and the set of billing metrics. The program instructions further cause the processor to detect at least one anomaly based on the application of the ML model to the set of utilization metrics and the set of billing metrics.

In various embodiments of the disclosure, the program instructions further cause the processor set to determine an application code update of the first application code to a second application code. The program instructions further cause the processor to detect a subset of application code changes in the first application code based on the determination of the application code update. The set of changes includes the subset of application code changes. The program instructions further cause the processor to apply the language model to the detected subset of application code changes. The program instructions further cause the processor to determine a first subset of root causes of the set of root causes based on the application of the language model to the detected subset of application code changes. The program instructions further cause the processor to output the first subset of root causes.

In various embodiments of the disclosure, the program instructions further cause the processor set to compare the first application code with a second application code. The first application code is associated with a first version of the application and the second application code is associated with a second version of the application. The program instructions further cause the processor to detect the subset of application code changes in the first application code based on the comparison.

In various embodiments of the disclosure, the program instructions further cause the processor set to determine an application configuration update of the first application configuration to a second application configuration. The program instructions further cause the processor to detect a subset of application configuration changes in the first application configuration based on the determination of the application configuration update. The set of changes includes the subset of application configuration changes. The program instructions further cause the processor set to apply the language model to the detected subset of application configuration changes. The program instructions further cause the processor to determine a second subset of root causes of the set of root causes based on the application of the language model to the detected subset of application configuration changes. The program instructions further cause the processor to output the second subset of root causes.

In various embodiments of the disclosure, the program instructions further cause the processor set to compare the first application configuration with a second application configuration. The first application configuration is associated with a first version of the application, and the second application configuration is associated with a second version of the application. The program instructions further cause the processor to detect the subset of application configuration changes in the first application configuration based on the comparison.

In various embodiments of the disclosure, the program instructions further cause the processor set to detect a subset of service configuration changes in the service configuration associated with the cloud platform. The set of changes includes the subset of service configuration changes. The program instructions further cause the processor to apply the language model to the detected subset of service configuration changes. The program instructions further cause the processor set to determine a third subset of root causes of the set of root causes based on the application of the language model to the detected subset of service configuration changes. The program instructions further cause the processor set to output the third subset of root causes.

In various embodiments of the disclosure, the program instructions further cause the processor set to determine a set of scores based on the determined set of root causes. The program instructions further cause the processor to associate the set of scores with the determined set of root causes. The program instructions further cause the processor set to determine a ranked list of root causes based on the association of the set of scores with the determined set of root causes. The program instructions further cause the processor set to output the determined ranked list of root causes. The application is associated with one or more services. The determined ranked list of root causes is associated with the utilization of the one or more resources by at least one service of the one or more services.

In various embodiments of the disclosure, a computer-program product for determination of the set of root causes associated with the application is described. The computer program product includes one or more computer-readable storage media and program instructions stored in the one or more computer-readable storage media to perform operations that include receiving a set of utilization metrics associated with the application deployed on a cloud platform. The set of utilization metrics is indicative of a utilization of one or more resources by the application. The operations further include receiving a set of billing metrics associated with the application. The operations further include detecting at least one anomaly between the set of utilization metrics and the set of billing metrics based on the received set of utilization metrics and the received set of billing metrics. The operations further include detecting set of changes in at least one of a first application code associated with the application, a first application configuration associated with the application, or a service configuration associated with the cloud platform. The set of changes is detected based on the at least one anomaly. The operations further include applying a language model to the detected set of changes. The operations further include determining the set of root causes associated with the utilization of the one or more resources by the application. The set of root causes is determined based on the application of the language model to the detected set of changes. The operations further include outputting the determined set of root causes.

In various embodiments of the disclosure, the operations further include applying a machine learning (ML) model to the set of utilization metrics and the set of billing metrics. The operations further include detecting the at least one anomaly based on the application of the ML model to the set of utilization metrics and the set of billing metrics.

In various embodiments of the disclosure, the application is associated with one or more services. The determined set of root causes is associated with the utilization of the one or more resources by at least one service of the one or more services.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

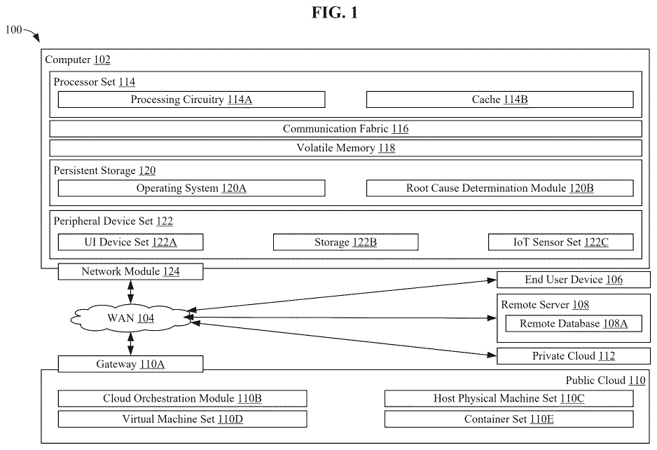

FIG. 1 is a diagram that illustrates a computing environment for determination of root causes for the increase in running cost of an application, in accordance with an embodiment of the disclosure. With reference to FIG. 1, there is shown a computing environment 100 that contains an example of an environment for the execution of at least some of the computer code involved in performing the disclosed methods, such as a root cause determination module 120B. In addition to the root cause determination module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the root cause determination module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though it is not shown in a cloud in FIG. 1. The computer 102 is not needed to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the root cause determination module 120B in persistent storage 120.

The communication fabric 116 is the signal conduction path that allows the various components of computer 102 to communicate with the aforementioned components associated with the computer 102. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the root cause determination module 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of distinct types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

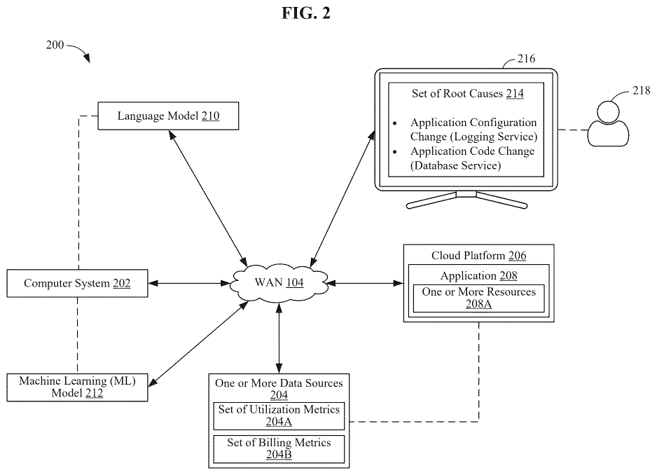

FIG. 2 is a diagram that illustrates an environment for determination of root causes for the increase in running cost of an application, in accordance with an embodiment of the disclosure. FIG. 2 is explained in conjunction with elements from FIG. 1. With reference to FIG. 2, there is shown a diagram of a network environment 200. The network environment 200 includes a computer system 202, one or more data sources 204, a cloud platform 206, and an application 208. The network environment 200 further includes a language model 210, a machine learning (ML) model 212, and a user device 216. The one or more data sources 204 include a set of utilization metrics 204A and a set of billing metrics 204B. The application 208 utilizes one or more resources 208A. The user device 216 renders a set of root causes 214. The user device 216 is associated with a user 218. The network environment 200 further includes the WAN 104 of FIG. 1. In an embodiment of the disclosure, the user device 216 is an exemplary embodiment of the EUD 106. Similarly, the computer system 202 is an exemplary embodiment of the computer 102 in FIG. 1.

The computer system 202 includes suitable logic, circuitry, and/or interfaces for determination of the set of root causes 214 for the increase in the running cost of the application 208. The application 208 is deployed on the cloud platform 206. The computer system 202 receives the set of utilization metrics 204A associated with the application 208. The set of utilization metrics 204A is indicative of utilization of one or more resources 208A by the application 208. The computer system 202 further receives the set of billing metrics associated with the application 208. The computer system 202 further detects at least one anomaly between the set of utilization metrics 204A and the set of billing metrics 204B. The detection of the at least one anomaly is based on the received set of utilization metrics 204A and the received set of billing metrics 204B. The computer system 202 further detects a set of changes based on the at least one anomaly. The set of changes are detected in at least one of a first application code associated with the application 208, a first application configuration associated with the application 208, or a service configuration associated with the cloud platform 206. The computer system 202 further applied the language model 210 to the detected set of changes. The computer system 202 further determines the set of root causes 214 based on the application of the language model 210 to the detected set of changes. The computer system 202 further outputs the determined set of root causes 214.

By way of example, and not by limitation, the computer system 202 may be embodied as a cloud-based service, a cloud-based application, a cloud-based platform, a remote server-based service, a remote server-based application, a remote server-based platform, or a virtual computing system.

Each data source of the one or more data sources 204 corresponds to an organized collection of data that may be stored and accessed electronically from a computer system (such as the computer system 202). Each of the one or more data sources 204 may be designed to manage, store, retrieve, and update data efficiently. In an exemplary implementation, each data source of the one or more data sources 204 may correspond to a database. In such an implementation, the structure of the database corresponding to each data source of the one or more data sources 204 typically involves tables, records, and fields that can be managed through various database management systems (DBMS).

In an embodiment of the disclosure, each data source of the one or more data sources 204 stores application repositories. The application repositories include application binaries, source code, libraries, and metadata of the application 208. The application repositories are utilized to store, process, deploy, and maintain the application 208 deployed on the cloud platform 206. In an embodiment of the disclosure, continuous integration/continuous deployment (CI/CD) is utilized to process and trigger deployment of the application 208 on the cloud platform 206. The CI/CD refers to a set of software deployment techniques that are utilized by the computer system 202 to streamline the integration of changes (e.g., the application code change, or the application configuration change), testing the changes, and deployment of the application 208 on the cloud platform 206. The CI refers to merging the application code changes or the application configuration changes into the application repository associated with the application 208. The CD refers to deploying the changes that are merged into the application code or the application configuration of the application 208. The computer system utilizes operational pipelines to deploy the application 208 on the cloud platform 206. The operational pipelines refer to automated workflows that are configured for continuous deployment of the application 208 on the cloud platform 206.

By way of example, and not by limitation, the developer of the application 208 updates the application code of the application 208. The CI detects the changes in the application code of the application 208 and further retrieves the changes in the application code of the application 208. The CI further processes the application code changes and stores the application code update in the application repository of the application 208. The CD further retrieves the application code changes from the application repository and triggers the operation pipelines. The operational pipelines further deploy the application 208 on the cloud platform 206.

In an embodiment of the disclosure, each data source of the one or more data sources 204 stores the set of utilization metrics 204A. The set of utilization metrics 204A is indicative of the utilization of the one or more resources 208A by the application 208. In an embodiment of the disclosure, each data source of the one or more data sources 204 stores the set of billing metrics 204B associated with the application 208. In an embodiment, the set of billing metrics 204B is indicative of cost associated with the set of utilization metrics 204A indictive of the utilization of the one or more resources 208A by the application 208. In an embodiment of the disclosure, the one or more data sources 204 are connected with the application programming interfaces (APIs) of the application 208 deployed on the cloud platform 206. Examples of each data source of one or more data sources 204 may include but are not limited to, a relational database, a Non-Structured Query Language (SQL) database, a hierarchical database, a network database, a transactional database, a data warehouse, and a distributed database.

The cloud platform 206 is a comprehensive and integrated framework of cloud computing services that provides infrastructure, tools, and frameworks for the development, deployment, and management of applications and services in a cloud environment. The cloud computing services include, but are not limited to, infrastructure as a service (IaaS), platform as a service (PaaS), and database as a service (DBaaS). The IaaS provides virtual computing resources for the application 208 deployed on the cloud platform 206. The PaaS provides an environment for the development and deployment of the application 208. The DBaaS provides database solutions to access and manage databases associated with the application 208. The cloud environment enables the deployment, management, and scaling of the application 208 hosted on the cloud platform 206. The cloud platform 206 provides a consistent runtime environment by encapsulating the application 208 and the dependencies of the application 208 within containers, ensuring seamless operation across various computing environments.

In an embodiment of the disclosure, the application 208 is hosted on the cloud platform 206. The cloud platform 206 provides the infrastructure, tools, and frameworks for the development, and management of the application 208 hosted on the cloud platform 206. The hosting of the application 208 on the cloud platform 206 refers to a process of deploying and running the application 208 on cloud platform 206 (for e.g., a server or a group of servers) that is accessible over the internet. The application 208 hosted on the cloud platform 206 is stored and executed on the infrastructure of the cloud platform 206 rather than on local servers or devices.

The application 208 includes a set of instructions, routines, or algorithms that are designed to perform specific tasks and functions. The set of instructions, the routines, or the algorithms may be stored in a computer-readable medium associated with each data source of the one or more data sources 204. In an embodiment of the disclosure, the computer system 202 is configured to execute the one or more processes of the application 208. In various embodiments of the disclosure, the computer system 202 is configured to execute the one or more processes of the application 208 on the user device 216. The one or more processes include, but are not limited to, data retrieval processes, data validation processes, data storage processes, data rendering processes, and data transmitting processes. In an embodiment of the disclosure, the application 208 is deployed on the cloud platform 206. The application 208 integrates with software services through application programming interfaces (APIs). Examples of the application 208 include, but are not limited to, social media application, banking application, fitness and well-being applications, and gaming applications.

The language model 210 may be a piece of software that leverages natural language processing (NLP) and machine learning techniques to understand, generate, and manipulate human language. For example, the language model 210 may correspond to a large language model (LLM) that is specifically designed for tasks related to language understanding and generation on a large scale. Certain characteristics of the LLM may include, but are not limited to, natural language understanding, text generation, semantic understanding, transfer learning, multimodal capabilities, continuous learning, and user interaction. For example, the LLM model for language processing may be implemented using Generative Pre-trained Transformer (GPT), Bidirectional Encoder Representations from Transformers (BERT), and the like.

Further, the LLM may be a type of ML model 212 specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of distinct parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted that a base model in an LLM refers to a trained model that has been trained on a large corpus of data for a general natural language understanding and generation task. The trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping each parameter or the majority of the base model's parameters frozen. In particular, the adapter is used to fine-tune the base model for a specific downstream task without extensively modifying its pre-trained parameters. This approach is beneficial when computational resources or labeled task-specific data are limited. In an embodiment of the disclosure, the language model 210 is embodied as a cloud-based service, a cloud-based application, or a cloud-based platform.

In an embodiment of the disclosure, the language model 210 determines each subset of root causes of the set of root causes 214. In an embodiment of the disclosure, the language model 210 analyzes the set of changes in at least of the first application code associated with the application 208, the first application configuration associated with the application 208, and the service configuration associated with the cloud platform 206 to determine the set of root causes 214.

The ML model 212 corresponds to a computational network or a system of artificial neurons, arranged in a plurality of layers, as nodes. The plurality of layers of the ML model 212 may include an input layer, one or more hidden layers, and an output layer. Each layer of the plurality of layers may include one or more nodes (or artificial neurons). Outputs of nodes present in the input layer may be coupled to at least one node of hidden layer(s). Similarly, inputs of each hidden layer may be coupled to outputs of at least one node in a plurality of layers of the ML model 212. Outputs of each hidden layer may be coupled to inputs of at least one node in the plurality of layers of the ML model 212. Node(s) in the final layer may receive inputs from at least one hidden layer to output a result. The number of layers and the number of nodes in each layer may be determined from hyper-parameters of the ML model 212. Such hyper-parameters may be set before or while training the ML model 212 on a training dataset.

Each node of the ML model 212 may correspond to a mathematical function (e.g., a sigmoid function or a rectified linear unit) with a set of parameters, tuneable during training of the network. The set of parameters may include, for example, a weight parameter, a regularization parameter, and the like. Each node may use the mathematical function to compute an output based on one or more inputs from nodes in the plurality of layer(s) (e.g., previous layer(s)) of the ML model 212. Every or some of the nodes of the ML model 212 may correspond to the same or a different mathematical function.

In training of the ML model 212, one or more parameters of each node of the ML model 212 may be updated based on whether an output of the final layer for a given input (from the training dataset) matches a correct result based on a loss function for the ML model 212. The above process may be repeated for the same or a different input until a minima of loss function may be achieved, and a training error may be minimized. Several methods for training are known in art, for example, gradient descent, stochastic gradient descent, batch gradient descent, gradient boost, meta-heuristics, and the like.

The ML model 212 may include electronic data, such as, for example, a software program, code of the software program, libraries, applications, scripts, or logic or instructions for execution by a processing device, such as processor set. The ML model 212 may include code and routines configured to enable a computing device, such as the computer system 202 to perform one or more operations. Additionally, or alternatively, the ML model 212 may be implemented using hardware including a processor, a microprocessor (e.g., to perform or control performance of one or more operations), a field-programmable gate array (FPGA), or an application-specific integrated circuit (ASIC). Alternatively, in some embodiments, the first ML model 212 may be implemented using a combination of hardware and software. Although in FIG. 2, the ML model 212 is shown as a separate entity from the computer system 202, the disclosure is not so limited. Accordingly, in some embodiments, the ML model 212 may be integrated within the computer system 202, without deviation from scope of the disclosure. Examples of the ML model 212 may include, but are not limited to, a deep neural network (DNN), a convolutional neural network (CNN), a CNN-recurrent neural network (CNN-RNN), an artificial neural network (ANN), a fully connected neural network, and/or a combination of such networks.

The user device 216 includes suitable logic, circuitry, and/or interfaces that are configured to execute one or more tasks. The user device 216 performs the one or more tasks such as receiving application data, processing the application data, and transmitting the application data. The application data includes, but is not limited to, the set of utilization metrics 204A, the set of billing metrics 204B, and the set of root causes 214. The user device 216 includes a central processing unit (CPU) and a memory unit. Examples of the user device 216 include one but are not limited to, a computer workstation, a laptop, a smartphone, a cellular phone, a mobile phone, a consumer electronic (CE) device, an Internet of Things (IoT) device, a computing device, or the like.

In an alternate embodiment of the disclosure, the computer system 202 renders the set of root causes 214 on the user device 216. Examples of the user device 216 include one but are not limited to, a computer workstation, a laptop, a smartphone, a cellular phone, a mobile phone, a consumer electronic (CE) device, an Internet of Things (IoT) device, a computing device, a mainframe machine, a server, or the like.

In operation, the computer system 202 receives the set of utilization metrics 204A associated with the application 208. The application 208 is deployed on the cloud platform 206. The set of utilization metrics 204A is indicative of the utilization of the one or more resources 208A by the application 208. The set of utilization metrics 204A is a collection of quantitative measures that collectively represent consumption of the one or more resources 208A (say computational resources such as memory, storage, and the like) by the application 208 over time, characterized by time-stamped entries that allow for analysis of trends, patterns, and anomalies. The set of utilization metrics 204A includes metrics such as CPU utilization by the application 208, memory utilization by the application 208, storage utilization (or disk utilization) by the application 208, network bandwidth, and latency. The CPU utilization by the application 208 is indicative of utilization of the percentage of processing capacity by the application 208 over a specified time period (say 60 minutes). The memory utilization by the application 208 is indicative of the consumption of random access memory (RAM) by the application 208. The storage utilization by the application 208 is indicative of the utilization of a percentage of storage capacity by the application 208 of total storage capacity available for the application 208. The network bandwidth associated with the application 208 is indicative of a volume of data transmitted to and from the application 208 and the cloud platform 206 over the WAN 104. By way of example, and not by limitation, the network bandwidth is measured in bits per second. For example, the volume of data is transmitted to the application 208 and the cloud platform 206 over the WAN 104 at a rate of 100 megabits per second. The latency associated with the application 208 is indicative of time delay between transmission of a request and reception of a response between the application 208 and the cloud platform 206. By way of example, and not by limitation, the latency is measured in milliseconds. For example, the latency for response of a request by the computer system 202 for receiving the set of utilization metrics 204A from the one or more data sources 204 is 100 milliseconds.

In an embodiment of the disclosure, the computer system 202 receives the set of utilization metrics 204A from the one or more data sources 204. By way of example, and not by limitation, the computer system 202 receives a first utilization metric associated with CPU utilization by the application 208 such as (11:00 AM: 30 requests per hour, 12:00 PM: 40 requests per hour, 01:00 PM: 60 requests per hour, 02:00 PM: 70 requests per hour, 03:00 PM: 80 requests per hour, 04:00 PM: 100 requests per hour). As discussed above, each request is associated with the utilization of the computational resources.

Further, the computer system 202 receives the set of billing metrics 204B associated with the application 208. The set of billing metrics 204B is indicative of the cost associated with the set of utilization metrics 204A. The cost associated with the set of utilization metrics 204A is determined based on a cost function that may be a mathematical function that determines the cost associated with the utilization of the one or more resources 208A by the application 208. Each metric of the set of billing metrics 204B is indicative of a cost associated with a corresponding metric of the set of utilization metrics 204A. The corresponding metric is indicative of the utilization of a corresponding resource by the application 208. The set of billing metrics 204B includes metrics such as CPU utilization cost, memory utilization cost, storage utilization cost, data transfer cost, and total utilization cost. The CPU utilization cost is indicative of a first cost associated with a measure of the percentage of time the CPU is actively performing tasks within a given time frame for the application 208. By way of example, and not by limitation, the CPU utilization cost is calculated based on a pricing structure associated with the cloud platform 206. The memory utilization cost is indicative of a second cost associated with the utilization of proportion of total memory assigned to the application 208 that is by the application 208. By way of example, and not by limitation, the memory utilization cost is calculated based on total memory hours consumption by the application 208. The storage utilization cost is indicative of a third cost value associated with the utilization of total storage capacity by the application 208. The data transfer cost is indicative of a fourth cost value associated with a maximum rate of data transfer. The maximum rate of data transfer is associated with the cloud platform 206. The total utilization cost is a total cost indicative of the aggregate cost incurred for utilization of the one or more resources 208A by the application 208. By way of example, and not by limitation, the total utilization cost is calculated based on the sum of the cost of each metric of the set of billing metrics 204B.

In an embodiment of the disclosure, the computer system 202 receives the set of billing metrics 204B from the one or more data sources 204. By way of example, and not by limitation, the cloud service provider charges ‘1 dollar’ for 100 requests associated with the utilization of the computational resources. The computer system 202 receives a first billing metric indicative of the CPU utilization cost by the application 208 such as (11:00 AM: 30 requests per hour (0.3 dollars), 12:00 PM: 40 requests per hour (0.4 dollars), 1:00 PM: 60 requests per hour (0.6 dollars), 2:00 PM: 70 requests per hour (0.7 dollars), 3:00 PM: 80 requests per hour (0.8 dollars), 4:00 PM: 100 requests per hour (1 dollar).

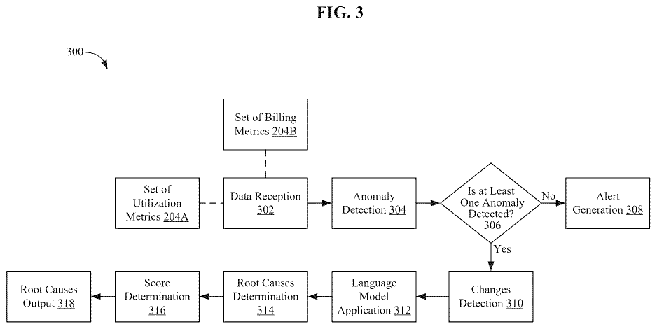

Thereafter, the computer system 202 detects the at least one anomaly between the set of utilization metrics 204A and the set of billing metrics 204B. An anomaly is defined as any deviation from the expected cost associated with the hosting of the application 208 on the cloud platform 206. In an embodiment of the disclosure, the computer system 202 receives historical data from the one or more data sources 204. The historical data includes a historical association between a historical set of utilization metrics and a historical set of billing metrics. The computer system 202 determines an association between the set of utilization metrics 204A and the set of billing metrics 204B based on the historical data. The computer system 202 further updates the historical data based on the determined association. In an embodiment of the disclosure, the computer system 202 detects the at least one anomaly based on the updated historical data. Details about the historical data are provided, in FIG. 3 and its corresponding description.

In an embodiment of the disclosure, an ML model 212 is applied to the set of utilization metrics 204A and the set of billing metrics 204B. The ML model 212 is trained on the historical data. In an embodiment of the disclosure, the computer system 202 detects the at least one anomaly based on the application of the ML model 212 to the received set of utilization metrics 204A and the received set of billing metrics 204B. Details about the application of the ML model 212 and anomaly detection based on the application of the ML model 212 are provided, for example, in FIG. 3.

By way of example, and not by limitation, the computer system 202 determines a first anomaly associated with the CPU utilization by the application 208 based on the application of the ML model 212 to the set of utilization metrics 204A and the set of billing metrics 204B. For example, the cloud service provides historically charges ‘10 dollars’ per 100 requests. The requests are associated with the utilization of the computing resources by the application 208. Further, the application code of the application 208 is updated. Upon the update in the application code of the application 208, the cloud service provider charges ‘14 dollars’ per 100 requests sent by the application 208 for utilization of the computing resources. The computer system 202 determines the first anomaly associated with the CPU utilization by the application 208 indicative of the cloud service provider charging ‘4 dollars’ extra per 100 requests as compared to the historical charges associated with the utilization of the computing resources by the application 208. The first anomaly is indicative of the increase in the cost associated with the utilization of the computing resources by the application 208.

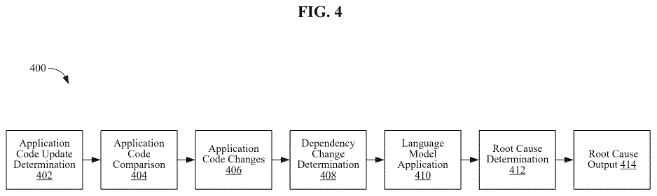

The computer system 202 further detects the set of changes based on the detected anomaly. The set of changes is detected in at least one of the application code associated with the application 208, the application configuration associated with the application 208, or the service configuration associated with the cloud platform 206. In an embodiment of the disclosure, the computer system 202 determines a subset of application code changes of the set of changes. The subset of application code changes is associated with changes detected in the first application code associated with the application 208. By way of example, and not by limitation, the subset of application code changes includes changes such as changes in the first application code to fix a bug in the application 208, changes in the first application code to upgrade libraries by the application 208, and changes in the first application code to modify algorithms in the application 208. Details about the determination of the subset of application code changes and the subset of application code changes are provided, in FIG. 4 and its corresponding description.

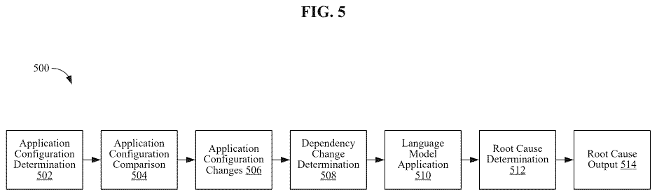

In an embodiment of the disclosure, the computer system 202 determines a subset of application configuration changes of the set of changes. The subset of application configuration changes is associated with changes detected in the first application configuration associated with the application 208. By way of example, and not by limitation, the subset of application configuration changes includes changes such as changes in the first application configuration to modify the allocation of resources for the application 208, changes in the first application configuration to modify firewall configurations of the application 208, and changes in the first application configuration to modify API keys associated with the API of the application 208. Details about the determination of the subset of application configuration changes and the subset of application configuration changes are provided, in FIG. 5 and its corresponding description.

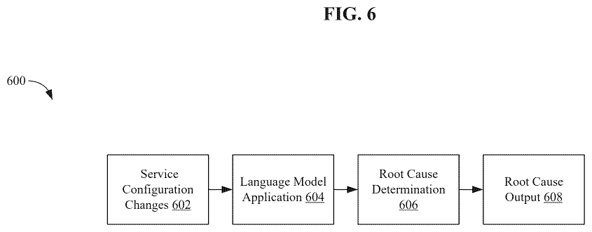

In an embodiment of the disclosure, the computer system 202 determines a subset of service configuration changes of the set of changes. The subset of service configuration changes is associated with changes detected in the service configuration associated with the cloud platform 206. By way of example, and not by limitation, the subset of service configuration changes includes changes such as changes in the service configuration to modify a configuration of cloud services of the cloud platform 206, and changes in the service configuration to modify integration of cloud services of the cloud platform 206. Details about the determination of the subset of service configuration changes and the subset of service configuration changes are provided, in FIG. 6 and its corresponding description.

Thereafter, the computer system 202 applies the language model 210 to the detected set of changes. In an embodiment of the disclosure, the language model 210 corresponds to a code assistant model that determines the set of root causes 214 associated with the increase in the running cost of the application 208 deployed on the cloud platform 206. The code assistant model is a specialized generative artificial intelligence (Gen AI) language model designed to assist software developers in the process of writing, debugging, and optimizing code. The code assistant model leverages advanced natural language processing techniques and extensive training in diverse programming languages, frameworks, and coding practices to understand and generate contextually relevant code snippets, documentation, and suggestions based on user input.

In an embodiment of the disclosure, the computer system 202 applies the language model 210 to the set of changes to determine the set of root causes 214 associated with the utilization of the one or more resources 208A by the application 208. The computer system 202 applies the language model 210 to the application code changes to determine the first subset of root causes associated with the subset of application code changes. The subset of application code changes is indicative of changes detected by the computer system 202 in the application code by the application 208. The changes in the application code are detected by comparing the first application code with the second application code. The first subset of root causes is determined based on the application of the language model 210 to the changes detected in the first application code of the application 208. In an alternate embodiment of the disclosure, the computer system 202 applies the language model 210 to the subset of application configuration changes to determine the second subset of root causes associated with the utilization of the one or more resources 208A by the application 208. The second subset of root causes is determined based on the application of the language model 210 to the changes detected in the first application configuration of the application 208. In an alternate embodiment of the disclosure, the computer system 202 applies the language model 210 to the subset of service configuration changes to determine the third subset of root causes associated with the utilization of the one or more resources 208A by the application 208. The third subset of root causes is determined based on the application of the language model 210 to the changes detected in the service configuration of the cloud platform 206.

To this end, the computer system 202 outputs the set of root causes 214. In an embodiment of the disclosure, the computer system 202 outputs a ranked list of the root causes. The ranked list of the root causes is indicative of an ordered list of the set of root causes 214. The ordered list is indicative of a sequence of root causes of the set of root causes 214 in a specific order that may be based on a contribution of a corresponding root cause in the increase of the cost associated with hosting the application 208 in the cloud platform. In an embodiment, each root cause of the set of root causes 214 is accessed by its position (or index) within the ordered list of the set of root causes 214 that may be determined based on the set of scores. In an embodiment of the disclosure, the computer system 202 renders an alert indicative of the set of root causes 214. In an alternate embodiment of the disclosure, the computer system 202 outputs the set of root causes 214 on the user device 216. Details about the determination of the ranked list of root causes and the ranked list of root causes are provided, in FIG. 3.

FIG. 3 is a diagram that illustrates exemplary operations for the determination of the root causes for the increase in the running cost of the application, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 316, as described herein. The exemplary operations illustrated in the block diagram 300 start at 302 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300 can be divided into additional blocks, combined into fewer blocks, or eliminated, depending on the implementation.

At 302, a data reception operation is executed. In the data reception operation, the computer system 202 receives the set of utilization metrics 204A associated with the application 208. The application 208 is deployed on the cloud platform 206. The cloud platform 206 provides the infrastructure, tools, and frameworks for the development, and management of the application 208 hosted on the cloud platform 206. The cloud platform 206 provides on-demand access to computing resources (such as storage, memory, and the like) to the application 208 through the internet. The cloud platform 206 dynamically allocates computing resources for the application 208 based on the operational requirements of the application 208. The set of utilization metrics is the collection of quantitative measures that collectively represent consumption of the one or more resources 208A (say computational resources such as the memory, the storage, and the like) by the application 208 over time, characterized by time-stamped entries. In an embodiment of the disclosure, the computer system 202 receives the set of utilization metrics 204A from the one or more data sources 204.

In an embodiment of the disclosure, the set of utilization metrics 204A includes the first utilization metric associated with the CPU utilization by the application 208. The first utilization metric is indicative of the measure of the percentage of time the CPU is actively performing tasks within a given time frame for the application 208. The set of utilization metrics further includes a second utilization metric associated with the memory utilization by the application 208. The second utilization metric is indicative of utilization of the proportion of total memory assigned to the application 208 that is by the application 208. The set of utilization metrics 204A further includes a third utilization metric associated with the storage utilization by the application 208. The third utilization metric is indicative of utilization of the percentage of the storage capacity by the application 208 of the total storage capacity available for the application 208. The set of utilization metrics 204A further includes a fourth utilization metric associated with the network bandwidth associated with the application 208. The fourth utilization metric is indicative of the maximum rate of data transfer. The maximum rate of data transfer is indicative of the data transmitted over the WAN 104. The data is transferred between the application 208 and the cloud platform 206. Further, the set of utilization metrics 204A includes a fifth utilization metric associated with the latency associated with the application 208. The fifth utilization metric is indicative of the time delay between the transmission of the request and reception of the response associated with the request transmitted between the application 208 and the cloud platform 206. Furthermore, the set of utilization metrics 204A includes a sixth utilization metric associated with the utilization of the one or more services by the application 208 that are provided by the cloud platform 206. For example, the application 208 utilizes a messaging service provided by the cloud platform 206 in which the sixth utilization metric is indicative of the count of the messages that are sent from the application 208 and the count of the messages that are received by the application 208. For example, the application 208 utilizes a database service provided by the cloud platform 206 in which the sixth utilization metric is indicative of the count of read operations that are executed by the application 208 in the database of the application 208, and the count of the write operations that are executed by the application 208 in the database of the application 208.

By way of example, and not by limitation, the computer system 202 receives the set of utilization metrics 204A. The set of utilization metrics 204A includes the first utilization metric associated with the CPU utilization by the application 208, and the second utilization metric associated with memory utilization by the application 208. The set of utilization metrics 204A can be represented in the Table 1 present below:

TABLE 1
Set of Utilization Metrics 204A

| | CPU Utilization | |
|---|---|---|
| | (Number of requests | Memory Utilization |
| Timestamp | per day) | (Daily basis) |
| 01-01-2025 (10:00 AM) | 100 | 4 GB of 16 GB |
| 02-01-2025 (10:00 AM) | 200 | 10 GB of 16 GB |
| 03-01-2025 (10:00 PM) | 400 | 8 GB of 16 GB |
| 04-01-2025 (10:00 PM) | 500 | 6 GB of 16 GB |
| 05-01-2025 (10:00 PM) | 300 | 12 GB of 16 GB |
| 06-01-2025 (10:00 PM) | 800 | 11 GB of 16 GB |
| 01-01-2025 (10:00 PM) | 1000 | 15 GB of 16 GB |

The computer system 202 further receives the set of billing metrics 204B associated with the application 208. The set of billing metrics 204B is indicative of the cost associated with the set of utilization metrics 204A. Each metric of the set of billing metrics 204B is indicative of the cost associated with the corresponding metric of the set of utilization metrics 204A. The corresponding metric is indicative of the utilization of the corresponding resource by the application 208. In an embodiment of the disclosure, the computer system 202 receives the set of billing metrics 204B from the one or more data sources 204.

In an embodiment of the disclosure, the set of billing metrics 204B includes the first billing metric indicative of the total cost associated with each resource type of the one or more resources 208A. In an embodiment of the disclosure, the first billing metric includes the cost associated with the CPU utilization by the application 208, the memory utilization by the application 208, the storage utilization (or disk utilization) by the application 208, the data transfer cost associated with the application 208, and the service utilization cost associated with the application 208. The CPU utilization cost is indicative of the first cost associated with the measure of the percentage of time the CPU is actively performing tasks within a given time frame. The memory utilization cost is indicative of the second cost associated with the utilization of the proportion of total memory assigned to the application 208 that is by the application 208. The storage utilization cost is indicative of the third cost associated with the utilization of the total storage capacity by the application 208. The data transfer cost is indicative of the fourth cost associated with the maximum rate of data transfer. The maximum rate of data transfer is associated with the cloud platform 206. The service utilization cost is indicative of the fifth cost associated with the utilization of the one or more services by the application 208 that are provided by the cloud platform 206. For example, the application 208 utilizes the messaging service provided by the cloud platform 206. The fifth cost value is calculated based on the count of the messages received by the application 208 and the count of the messages sent by the application 208. For example, the application 208 utilizes the database service provided by the cloud platform 206. The fifth cost value is calculated based on the count of read operations that are executed by the application 208 in the database of the application 208, and the count of the write operations that are executed by the application 208 in the database of the application 208. The total cost is indicative of the aggregate cost incurred for utilization of the one or more resources 208A by the application 208.

By way of example, and not by limitation, the computer system 202 receives the first billing metric of the set of billing metrics 204B. The total cost associated with the first billing metric is ‘10 dollars’ for the day ‘Jan. 1, 2025’. The cloud service provider historically charges ‘4 dollars’ per 1000 requests associated with CPU utilization. The cloud service provider historically charges ‘6 dollars’ for every ‘32 GB’ of memory utilization. The cloud service provider historically charges ‘2 dollars’ for 1 terabyte (TB) of data transferred from the cloud. The cloud service provider historically charges ‘6 dollars’ per 10 GB of storage utilization. The cost function associated with the first billing metric can be represented in the Table 2 present below:

TABLE 2
Cost Function

| Resource Type | Resource Cost |
|---|---|
| CPU Utilization | 2 dollars (500 requests) |
| Memory Utilization | 3 dollars (16 GB memory utilized) |
| Data transfer | 2 dollars (1 TB data transferred from the cloud) |
| Storage Utilization | 3 dollars (5 GB storage utilized) |

At 304, an anomaly detection operation is executed. In the anomaly detection operation, the computer system 202 detects the at least one anomaly between the set of utilization metrics 204A and the set of billing metrics 204B. The computer system 202 detects the at least one anomaly based on the received set of utilization metrics 204A and the set of billing metrics 204B. The at least one anomaly indicates an unexpected increase in the running cost of the application 208 such that the increase in the running cost of the application 208 is not associated with an increase in the utilization of the one or more services by the application 208 that are provided by the cloud platform 206. In an embodiment of the disclosure, the anomaly associated with the increase in the running cost of the application 208 is due to changes in the costs associated with the utilization of the one or more services that are provided by the cloud platform 206. In an alternate embodiment of the disclosure, the anomaly associated with the increase in the running cost of the application 208 is due to changes in the configuration of the application 208 such as the application code update, the application configuration update, or change in a count of services utilized by the application 208.

For example, the computer system 202 detects an anomaly in the running cost of the application 208 where the application 208 is associated with resizing the set of images uploaded by the user 218. The running cost of the application 208 is increased after the deployment of the current version of the application 208. The previous version of the application 208 utilizes a sequential approach to resize the set of images uploaded by the user 218. The sequential approach is the method of execution in which tasks (say resizing the set of images uploaded by the user) are performed in a linear order such that a second task is initialized upon the completion of a first task. Upon the application code update, the application 208 pre-processes the set of images uploaded by the user 218 and then resizes the set of images. The computer system 202 detects the anomaly associated with the increase in the running cost of the application 208 by detecting the deployment of the current version of the application 208. The computer system 202 further determines the root cause associated with the increase in the running cost of the application 208 corresponding to the addition of pre-processing of the set of images that contribute to the increase in the running cost of the application 208.

For example, the computer system 202 detects the anomaly in the running cost of the application 208. The running cost of the application 208 is increased due to the addition in the count of the services that are utilized by the application 208. Previously, the application 208 utilized the messaging service and the database service. Now, the application 208 utilizes the messaging service, the database service, and an authentication service. The computer system 202 detects the anomaly associated with the increase in the running cost of the application 208 by detecting the increase in the count of the services that are utilized by the application 208. The computer system 202 further determines the root cause associated with the increase in the running cost of the application 208 corresponding to the utilization of the authentication service by the application 208.

In an embodiment of the disclosure, the computer system 202 applies the ML model 212 to the set of utilization metrics 204A and the set of billing metrics 204B. The ML model 212 is the pre-trained model, trained on the historical data. Upon the application of the ML model 212, the computer system 202 detects the at least one anomaly between the set of utilization metrics 204A and the set of billing metrics 204B based on the updated historical data.

By way of example, and not by limitation, the computer system 202 determines the first anomaly associated with the CPU utilization by the application 208 based on the application of the ML model 212 to the received set of utilization metrics 204A and the received set of billing metrics 204B. For example, the cloud service provider historically charges ‘100 dollars’ per 100 requests associated with the CPU utilization by the application 208. The computer system 202 determines the first anomaly associated with the CPU utilization by the application 208. The first billing metric associated with the CPU utilization by the application 208 can be represented in the Table 3 present below:

TABLE 3
First Billing Metric

| | CPU Utilization | CPU Utilization Cost |
|---|---|---|
| | (Number of requests | (10 dollars per 100 |
| Timestamp | per day) | requests) |
| 01-01-2025 (10:00 AM) | 300 | 30 |
| 02-01-2025 (10:00 AM) | 500 | 50 |
| 03-01-2025 (10:00 PM) | 600 | 60 |
| 04-01-2025 (10:00 PM) | 700 | 140 |
| 05-01-2025 (10:00 PM) | 800 | 160 |
| 06-01-2025 (10:00 PM) | 1000 | 200 |
| 01-01-2025 (10:00 PM) | 1200 | 240 |

In an embodiment, at the timestamp ‘Apr. 1, 2025, 10:00 PM’, changes in the application code of the application 208 are executed. From timestamp ‘Apr. 1, 2025, 10:00 PM’ the cloud service provider charges ‘20 dollars’ per 100 requests. As per the historical charges, the cloud service provider charged ‘10 dollars’ per 100 requests. The computer system 202 detects the first anomaly indicative of the increase in cost associated with the CPU utilization from the timestamp ‘Apr. 1, 2025, 10:00 AM’.

In an embodiment of the disclosure, the computer system 202 receives the historical data from the one or more data sources 204. The historical data includes patterns between the utilization of each resource of the one or more resources by the application 208 and the cost generated for the utilization of the corresponding resource by the application 208. The historical data includes the historical association between the historical set of utilization metrics and the historical set of billing metrics. The historical set of utilization metrics is indicative of utilization of the one or more resources 208A by the application 208 over a specific period of time. The historical set of billing metrics is indicative of the cost function associated with the historical set of utilization metrics.

The computer system 202 determines an association between the set of utilization metrics 204A and the set of billing metrics 204B based on the historical data. The historical data includes historical associations between, by way of example, and not by limitation, utilization of the one or more resources 208A by the application 208 and the cost associated with the utilization of the one or more resources 208A by the application 208.

The computer system 202 updates the historical data based on the determined association between the set of utilization metrics 204A and the set of billing metrics 204B. The computer system 202 updates the historical data by updating the determined association to the historical data to generate the updated historical data. In an embodiment of the disclosure, the computer system 202 detects the at least one anomaly between the set of utilization metrics 204A and the set of billing metrics 204B based on the updated historical data. With reference to the example in the table 3, changes in the application code of the application 208 are executed. From timestamp ‘Apr. 1, 2025, 10:00 PM’ the cloud service provider charges ‘20 dollars’ per 100 requests. As per the historical charges, the cloud service provider charged ‘10 dollars’ per 100 requests. The computer system 202 detects the first anomaly by comparing the historical charges with the charges that are charged by the cloud service provider. The first anomaly is indicative of the increase in cost associated with the CPU utilization from the timestamp ‘Apr. 1, 2025, 10:00 AM’ as the cloud service provider charges ‘20 dollars’ per 100 requests as compared to the historical charges (‘10 dollars’ per 100 requests).

The computer system 202 detects the at least one anomaly between the set of utilization metrics 204A and the set of billing metrics 204B based on the application of the ML model 212 to the set of utilization metrics 204A and the set of billing metrics 204B. The ML model 212 is the pre-trained model which utilizes the updated historical data to determine the at least one anomaly between the set of utilization metrics 204A and the set of billing metrics 204B. The ML model 212 is trained to detect an anomaly associated with an unexpected increase in the cost of utilization of one or more resources 208A by the application 208. The ML model 212 analyzes the patterns and the relationships between each metric of the set of utilization metrics 204A and the corresponding metric associated with the set of billing metrics 204B based on the training dataset and then detects the at least one anomaly. By way of example, and not by limitation, the anomalies include an unexpected increase in the running cost of the application 208 due to by way of example, and not by limitation, high CPU utilization, excessive memory utilization, and excessive network latency.

At 306, the computer system 202 determines if the at least one anomaly is detected in the cost associated with the utilization of the one or more resources 208A by the application 208. In an embodiment of the disclosure, if the at least one anomaly is detected, the control is transferred to 310. Alternatively, if the at least one anomaly is not detected, the control is transferred to 308.

At 308, if the at least one anomaly is not detected, then the computer system 202 generates an alert. The alert corresponds to an increase in the cost associated with the application 208 based on the increase in the utilization of the one or more resources 208A by the application 208.

At 310, a changes detection operation is executed. In the changes detection operation, the computer system 202 detects the set of changes based on the detected anomaly. The set of changes is detected in at least one of the application code associated with the application 208, the application configuration associated with the application 208, or the service configuration associated with the cloud platform 206.

In an embodiment of the disclosure, the computer system 202 determines the subset of application code changes of the set of changes. The subset of application code changes is detected in the first application code associated with the application 208. The application code refers to a set of instructions and logic written in a programming language that defines the behavior and functionality of the application 208. The application code encompasses a plurality of components, including algorithms, data structures, and user interface elements, which work together to perform specific tasks. The application code is typically organized into modules or classes, facilitating maintainability, scalability, and reusability, and is executed by a runtime environment or application server, enabling interaction with system resources, databases, and external services. Details about the determination of the subset of application code changes and the subset of application code changes are provided, in FIG. 4 and its corresponding description.

In an embodiment of the disclosure, the computer system 202 determines the subset of application configuration changes of the set of changes. The subset of application configuration changes is detected in the first application configuration associated with the application 208. The application configuration refers to the settings and the parameters indicating the behavior and operational characteristics of the application 208. The behavior and operational characteristics of the application 208 define how the application 208 functions and interacts with user 218. Details about the determination of the subset of application configuration changes and the subset of application configuration changes are provided, in FIG. 5 and its corresponding description.

In an embodiment of the disclosure, the computer system 202 determines the subset of service configuration changes of the set of changes. The subset of service configuration changes is detected in the service configuration associated with the cloud platform 206. The service configuration refers to the systematic arrangement and specification of parameters, settings, and options of the service associated with the cloud platform 206. The parameters determine the behavior and operational characteristics of the service within the cloud platform 206. The service configuration encompasses a plurality of elements, including service endpoints, authentication credentials, resource allocation, load balancing settings, and communication protocols, which collectively define the interaction of the service with components present in the computer system 202. Details about the determination of the subset of service configuration changes and the subset of service configuration changes are provided, in FIG. 6 and its corresponding description.

At 312, a language model application operation is executed. In the language model application operation, the computer system 202 applies the language model 210 to the detected set of changes. In an embodiment, the language model 210 corresponds to the code assistant model that determines the set of root causes 214 associated with the increase in the running cost of the application 208 deployed on the cloud platform 206. The language model 210 is trained based on historical detection data. The historical detection data includes historical patterns associated with the determination of a root cause based on a detected change in at least one of the application code associated with the application 208, the application configuration associated with the application 208, and the service configuration associated with the cloud platform 206. By way of example, and not by limitation, the historical detection data includes a first pattern indicative of a 5 percent increase in the total cost associated with application 208 due to the addition of one loop in a nested loop of the first application code of the application 208. The language model 210 utilizes the first pattern of the historical detection data to determine the subset of application code changes. For example, the application 208 uses a first nested loop to authenticate user credentials. The application 208 utilizes 2 GB RAM in authenticating the user credentials. Upon addition of a first loop in the first nested loop, the application 208 utilizes 2.1 GB RAM to authenticate the user credentials. The language model 210 utilizes the first pattern to determine the increase in the utilization of the RAM.

In an embodiment of the disclosure, the language model 210 analyzes the set of changes. The set of changes includes at least one of the subset of application code changes, the subset of application configuration changes, or a subset of service configuration changes. The application code changes include changes detected in the first application code associated with the application 208. The subset of application configuration changes includes changes detected in the first application configuration associated with the application 208. The subset of service configuration changes includes changes detected in the service configuration associated with the cloud platform 206. Upon the analysis of the set of changes, the language model 210 determines the set of root causes 214.

In an embodiment of the disclosure, the computer system 202 applies the language model 210 to the subset of application code changes. The computer system 202 determines the first subset of root causes based on the application of the language model 210 to the application code changes. In an alternate embodiment of the disclosure, the computer system 202 applies the language model 210 to the subset of application configuration changes. The computer system 202 determines the second subset of root causes based on the application of the language model 210 to the subset of application configuration changes. In an alternate embodiment of the disclosure, the computer system 202 applies the language model 210 to the subset of service configuration changes. The computer system 202 determines the third subset of root causes based on the application of the language model 210 to the subset of service configuration changes. Details about the subset of application code changes are provided, in FIG. 4 and its corresponding description. Details about the subset of application configuration changes are provided, in FIG. 5 and its corresponding description. Details about the subset of service configuration changes are provided, in FIG. 6 and its corresponding description.

At 314, a set of root causes determination operation is executed. In the set of root causes determination operation, the computer system 202 determines the set of root causes 214 based on the application of the language model 210 to the detected set of changes. In an alternate embodiment of the disclosure, the computer system 202 determines the set of root causes 214 based on the application of a static analysis tool to the detected set of changes. The static analysis tool refers to a software application that performs automated analysis of the application code. The static analysis tool examines the structure, syntax, and semantics of the application code to identify potential defects, vulnerabilities, and adherence to coding standards. The static analysis tool utilizes a plurality of techniques, such as pattern matching, data flow analysis, and control flow analysis, to detect issues such as syntax errors, logical flaws, security vulnerabilities, and code quality concerns in the application code of the application 208. In an embodiment of the disclosure, the computer system 202 determines the first subset of root causes of the set of root causes 214 based on the application of the static analysis tool to the subset of application code changes detected in the first application code associated with the application 208. In an alternate embodiment of the disclosure, the computer system 202 determines the second subset of root causes of the set of root causes 214 based on the application of the static analysis tool to the subset of application configuration changes detected in the first application configuration associated with the application 208. In an alternate embodiment of the disclosure, the computer system 202 determines the third subset of root causes of the set of root causes 214 based on the application of the static analysis tool to the subset of service configuration changes detected in the service configuration associated with the cloud platform 206.

In an embodiment of the disclosure, the application 208 is associated with one or more services. By way of example, and not by limitation, the one or more services include computing services, storage services, database services, networking services, and security services. The determined set of root causes 214 is associated with the utilization of the one or more resources 208A by at least one service of the one or more services.

At 316, a score determination operation is executed. In the score determination operation, the computer system 202 determines a set of scores based on the determined set of root causes 214. Each score of the set of scores is associated with the corresponding root cause of the set of root causes 214. For example, a first score of the set of scores is associated with a first root cause of the set of root causes 214. Each score of the set of scores associated with the corresponding root cause is indicative of a weight of the corresponding root cause responsible for the increase in the running cost of the application 208. Each score of the set of scores is determined based on the increase in the utilization of the one or more resources 208A by the corresponding root cause of the set of root causes 214. The higher the increase in the utilization of the one or more resources 208A by a root cause, the higher is the score associated with the specified root cause. The computer system 202 further associates the set of scores with the determined set of root causes 214. The computer system 202 associates the set of scores with the set of root causes 214 based on the increase in the running cost of the application 208 by a root cause of the set of root causes 214. By way of example, and not by limitation, the set of scores includes scores such as low (1-4), medium (5-7), and high (8-10) indicative of the severity of the cause responsible for the increase in the running cost of the application 208. By way of example, and not by limitation, the first score associated with the first subset of root causes associated with the utilization of the one or more resources 208A by the application 208 corresponds to ‘9’ indicative of high. The first score corresponding to ‘9’ is indicative of maximum weight (or severity) of the first subset of root causes such that the first subset of root causes is the primary cause of the increase in the running cost of the application 208. Further, the computer system 202 determines a ranked list of root causes based on the association of the set of scores with the determined set of root causes 214. The ranked list is indicative of an ordered list of the set of root causes 214.

At 318, a set of root causes output operation is executed. In the set of root causes output operation, the computer system 202 outputs the determined set of root causes 214. In an embodiment of the disclosure, the computer system 202 renders the alert indicative of the set of root causes 214. In an alternate embodiment of the disclosure, the computer system 202 outputs the alert indicative of the ranked list of root causes. The computer system 202 renders the alert on the user device 216. The alert indicative of the set of root causes 214 corresponds to an increase in the utilization of the one or more resources 208A by the application 208.

FIG. 4 is a diagram that illustrates exemplary operations for detection of the subset of application code changes in the first application code for determination of the first subset of root causes, in accordance with an embodiment of the disclosure. FIG. 4 is explained in conjunction with elements from FIG. 1, FIG. 2, and FIG. 3. With reference to FIG. 4, there is shown the block diagram 400 that illustrates exemplary operations from 402 to 414, as described herein. The exemplary operations illustrated in the block diagram 400 start at 402 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400 can be divided into additional blocks, combined into fewer blocks, or eliminated, depending on the implementation.

At 402, an application code update determination operation is executed. In the application code update determination operation, the computer system 202 determines an application code update of the first application code to a second application code. In an embodiment of the disclosure, the computer system 202 determines the application code update of the first application code to the second application code by comparing the first version of the application 208 to the second version of the application 208. The application code refers to a set of instructions and statements that define the behavior, functionality, and logic of the application 208. The set of instructions is written in a programming language (say python). The update in the application code of the application 208 is determined based on the addition or deletion of a piece of code in the first application code. Upon the determination of the changes in the application code in the first application code, the computer system 202 determines the application code update. By way of example, and not by limitation, the application code may be changed by a developer of the application 208. The changes in the application code are executed to improve the overall efficiency, performance, and utilization of the one or more resources 208A by the application 208. In an embodiment of the disclosure, upon the changes in the application code, an increase in the cost of running the application 208 is observed. The increase in the running cost of the application 208 is due to utilization of the one or more resources 208A by the application 208.

At 404, the first application code is compared with the second application code. In an embodiment of the disclosure, the computer system 202 compares the first application code associated with a first version of the application 208 and the second application code associated with a second version of the application 208. By way of example, and not by limitation, the computer system 202 compares the first application code associated with the first version (say version 1.6.1) of the application 208 and the second application code associated with the second version (say version 1.6.2) of the application 208.

In an embodiment of the disclosure, the computer system 202 performs a textual comparison between the first application code and the second application code. The textual comparison detects differences in, by way of example, and not by limitation, syntax, and structure between the first application code and the second application code. In an alternate embodiment of the disclosure, the computer system 202 performs a semantic comparison between the first application code and the second application code. The semantic comparison detects differences such as, by way of example, and not by limitation, variable names, and code functionality between the first application code and the second application code.

In an alternate embodiment of the disclosure, the computer system 202 utilizes application code comparison tools to compare the first application code and the second application code. The application code comparison tools refer to software applications designed to analyze and compare different versions of source code or binary files to identify differences, changes, and similarities in the application configuration of the application 208. The application code comparison tools analyze and compare the first application code with the second application code by parsing the code. Further, the application code comparison tools apply one or more algorithms to identify differences (such as line-by-line or semantic comparisons). The application code comparison tools further output the changes in the application code.

At 406, an application code changes detection operation is executed. In the subset of application code changes detection operation, the computer system 202 detects the subset of application code changes based on the comparison of the first application code associated with the first version of the application 208 and the second application code associated with the second version of the application 208. In an embodiment of the disclosure, the set of changes includes the subset of application code changes.

By way of example, and not by limitation, the subset of application code changes includes the change in the first application code to the second application code such that the first application code and the second application code have the same functionality. For example, in the first application code, the application 208 receives the password from the user 218 and saves the password in the one or more data sources 204 in the form of plain text. In the second application code, the application 208 receives the password from the user 218, encrypts the password, and saves the encrypted password in the one or more data sources 204. The subset of application code changes further includes changes in the first application code to the second application code such that an additional feature is added from the first application code to the second application code.

At 408, a dependency change determination operation is executed. In the dependency change determination operation, the computer system 202 determines a first dependency change associated with the application 208. In an embodiment of the disclosure, the computer system 202 determines a first dependency score associated with the application 208 based on the detected application code changes. The application code changes include changes in the application code of the application 208 from the first application code to the second application code. The computer system 202 analyzes each change in the application code of the application 208 from the first application code to the second application code. Based on each change in the application code, the computer system 202 updates the first dependency score. Each change of the application code changes is indicative of a change in a service client dependency associated with the application 208. The service client dependency refers to a dependency between the service associated with the cloud platform 206 utilized by the user 218 associated with the application 208. The one or more resources 208A utilized by the user 218 are associated with the service. By way of example, and not by limitation, a first code change of the application code changes is indicative of an increase in the number of computational requests needed for user authentication. The increase in the utilization of computational resources is due to changes in the application code from the first application code to the second application code. The computer system 202 determines the first dependency score associated with the increase in the utilization of the computing resources by the application 208. By way of example, and not by limitation, a second code change of the application code changes is indicative of an increase in the memory utilized for the user authentication. The increase in the memory utilization is due to changes in the application code from the first application code to the second application code.

At 410, the language model application operation is executed. In the language model application operation, the computer system 202 applies the language model 210 to the detected subset of application code changes based on the determined first dependency change. In an embodiment of the disclosure, the computer system 202 applies the language model 210 to the application code changes. The language model 210 analyzes the first dependency change in the first application code to the second application code. Details about the language model are provided, for example in FIG. 2 and its corresponding description.

At 412, a root cause determination operation is executed. In the root causes determination operation, the computer system 202 determines the first subset of root causes of the set of root causes 214 based on the application of the language model 210 to the detected subset of application code changes. Upon the application of the language model 210 to the first set of changes, the language model 210 determines the first subset of root causes. The first subset of root causes is associated with the increase in the utilization of the one or more resources 208A by the application 208 based on the changes in the application code of the application 208. The first subset of root causes includes causes such as, by way of example, and not by limitation, the increase in the CPU utilization, the increase in the memory utilization, and increase in the storage utilization.

At 414, a root cause output operation is executed. In the first subset of root causes output operation, the computer system 202 outputs the first subset of root causes of the set of root causes 214. In an embodiment of the disclosure, the computer system 202 renders the alert indicative of the first subset of root causes on the user device 216. The alert indicative of the first subset of root causes corresponds to the increase in the running cost of the application 208 based on the utilization of the one or more resources 208A by the application 208.

FIG. 5 is a diagram that illustrates exemplary operations for detection of the subset of application configuration changes in the first application configuration for determination of the second subset of root causes, in accordance with an embodiment of the disclosure. FIG. 5 is explained in conjunction with elements from FIG. 1, FIG. 2, FIG. 3, and FIG. 4. With reference to FIG. 5, there is shown the block diagram 500 that illustrates exemplary operations from 502 to 514, as described herein. The exemplary operations illustrated in the block diagram 500 start at 502 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 500 can be divided into additional blocks, combined into fewer blocks, or eliminated, depending on the implementation.

At 502, an application configuration update determination operation is executed. In the application configuration update determination operation, the computer system 202 determines an application configuration update of the first application configuration to a second application configuration. In an embodiment of the disclosure, the computer system 202 determines the application configuration update of the first application configuration to the second application configuration by comparing the first version of the application 208 to the second version of the application 208. The application configuration refers to the settings, and parameters associated with the application 208. The parameters determine the behavior, operational characteristics, and environment-specific attributes of the application 208 deployed on the cloud platform 206. The update in the application configuration of the application 208 is determined based on the modifications in the parameters associated with the application 208. Upon the determination of the changes in the parameters associated with the application configuration in the first application configuration, the computer system 202 determines the application configuration update. The application configuration is changed by, by way of example, and not by limitation, a developer of the application 208, periodic updates of the codebase of the application 208, and updates in the application configuration based on the reception of a feedback from the user 218. The changes in the application configuration are executed to improve the overall efficiency, performance, and utilization of the one or more resources 208A by the application 208. In an embodiment of the disclosure, upon the changes in the application configuration, an increase in the cost of running the application 208 is observed. The increase in the running cost of the application 208 is due to utilization of the one or more resources 208A by the application 208.

By way of example, and not by limitation, the application configuration update is indicative of an addition of a table in the one or more data sources 204 associated with the first application configuration. The second application configuration is the updated first application configuration in which the table is added to the one or more data sources 204. For example, the one or more data sources 204 associated with the first application configuration includes a set of tables indicative of a unique identifier of a consumer, a count of products associated with the corresponding consumer, and an invoice associated with the corresponding consumer. The table indicative of a payment method associated with the corresponding consumer is added to the one or more data sources 204 associated with the first application configuration. The updated set of tables in the one or more data sources 204 is associated with the second application configuration. Upon the addition of the table in the set of tables, the one or more data sources 204 associated with the second application configuration includes the table indicative of the payment method associated with the corresponding consumer.

At 504, the first application configuration is compared with the second application configuration. In an embodiment of the disclosure, the computer system 202 compares the first application configuration associated with the first version of the application 208 and the second application configuration associated with the second version of the application 208. By way of example, and not by limitation, the computer system 202 compares the first application configuration associated with the first version (say version 1.7.1) of the application 208 and the second application configuration associated with the second version (say version 1.7.2) of the application 208.

In an embodiment of the disclosure, the computer system 202 utilizes a version control framework to compare the first application configuration to the second application configuration. The version control framework refers to a software application that manages changes associated with the source code of the application 208. The version control framework analyses changes in different versions of the application 208. In an embodiment of the disclosure, the version control framework compares the changes associated with the first version of the application 208 to the second version of the application 208.

In an alternate embodiment of the disclosure, the computer system 202 utilizes application configuration comparison tools to compare the first application configuration to the second application configuration. The application configuration comparison tools refer to software applications designed to analyze and compare different versions of source codes to identify differences, changes, and similarities in the application configuration of the application 208.

At 506, an application configuration changes detection operation is executed. In the subset of application configuration changes detection operation, the computer system 202 detects the subset of application configuration changes based on the comparison of the first application configuration associated with the first version of the application 208 and the second application configuration associated with the second version of the application 208. In an embodiment of the disclosure, the set of changes includes the subset of application configuration changes. By way of example, and not by limitation, the first application configuration and the second application configuration store configuration files to store the settings of the application 208. The subset of application configuration changes includes the change in the database of the application 208 from the first application configuration to the second application configuration. For example, the first application configuration utilizes a first database to store the configuration files of the application 208, while the second application configuration utilizes a second database to store the configuration files of the application 208.

At 508, the dependency change determination operation is executed. In the dependency change determination operation, the computer system 202 determines a second dependency change associated with the application 208. In an embodiment of the disclosure, the computer system 202 determines a second dependency score associated with the application 208 based on the detected subset of application configuration changes. The subset of application configuration changes includes changes in the application configuration of the application 208 from the first application configuration to the second application configuration. The changes in the application configuration of the application include, by way of example, and not by limitation, the addition of API keys to configuration files of the application 208, updating user authentication methods associated with the application 208, and the addition of a table in the one or more data sources 204 associated with the application 208. The computer system 202 analyzes each change in the application configuration of the application 208 from the first application configuration to the second application configuration. The computer system 202 compares the configuration file associated with the first application configuration of the application 208 with the configuration file associated with the second application configuration of the application 208. The comparison is executed to determine the addition, deletion, or modification of parameters in the application configuration files of the application 208 by utilizing methods such as, by way of example, and not by limitation, line-by-line comparison, and key-value comparison.

The computer system 202 updates the second dependency score, based on each change in the application configuration. The second dependency score refers to a quantitative measure indicative of a relationship between the service associated with the cloud platform 206 and the utilization of the application 208 associated with the service by user 218. Each change of the subset of application configuration changes is indicative of a change in the service client dependency associated with the application 208. The computer system 202 updates the second dependency score based on a count of the changes in the service client dependency. Each change of the subset of changes is associated with the increase in the running cost of the application 208 based on the utilization of the one or more resources 208A.

By way of example, and not by limitation, the first application configuration associated with the application 208 utilizes the first database of the one or more data sources 204 to store the user data. The second application configuration of the associated with the one or more data sources 204 utilizes the second database of the one or more data sources 204 to store the user data. The application configuration change of the subset of application configuration changes is indicative of an increase in the running cost of the application 208. The increase in the running cost is associated with the change in the database from the first database to the second database. The cost to store a specific amount of user data in the second database is higher as compared to the cost to store the specified user data in the first database. Executing a database query from the second database requires more computational resources as compared to the computational resources needed to execute the same query in the first database. The computer system 202 determines the second dependency score associated with the increase in the utilization of the computing resources by the application 208.

At 510, the language model application operation is executed. In the language model application operation, the computer system 202 applies the language model 210 to the detected subset of application configuration changes based on the determined second dependency change. In an embodiment of the disclosure, the computer system 202 applies the language model 210 to the subset of application configuration changes. The language model 210 analyzes the subset of application configuration changes based on the second dependency change in the first application configuration to the second application configuration. The language model 210 determines the second subset of root causes based on the analysis.

At 512, the root cause determination operation is executed. In the second subset of root causes determination operation, the computer system 202 determines the second subset of root causes of the set of root causes 214 based on the application of the language model 210 to the detected subset of application configuration changes. Upon the application of the language model 210 to the first set of changes, the language model 210 determines the second subset of root causes. The second subset of root causes is indicative of the increase in the running cost of the application 208 based on the application configuration change. The increase in the running cost of the application 208 is due to the change in the database of the application 208 from the first database to the second database. The increase in the running cost of the application 208 leads to, by way of example, and not by limitation, the increase in the CPU utilization, the increase in the memory utilization, and the increase in the storage utilization.

At 514, the root cause output operation is executed. In the second subset of root causes output operation, the computer system 202 outputs the second subset of root causes of the set of root causes 214. In an embodiment of the disclosure, the computer system 202 renders the alert indicative of the second subset of root causes on the user device 216. The alert indicative of the second subset of root causes corresponds to the increase in the running cost of the application 208 based on the utilization of the one or more resources 208A by the application 208.

FIG. 6 is a diagram that illustrates exemplary operations for detection of the subset of service configuration changes in the service configuration for determination of the third subset of root causes, in accordance with an embodiment of the disclosure. FIG. 6 is explained in conjunction with elements from FIG. 1, FIG. 2, FIG. 3, FIG. 4, and FIG. 5. With reference to FIG. 6, there is shown the block diagram 600 that illustrates exemplary operations from 602 to 608, as described herein. The exemplary operations illustrated in the block diagram 600 start at 602 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 600 can be divided into additional blocks, combined into fewer blocks, or eliminated, depending on the implementation.

At 602, a service configuration changes detection operation is executed. In the subset of service configuration changes detection operation, the computer system 202 detects the subset of service configuration changes in the service configuration associated with the cloud platform 206. In an embodiment of the disclosure, the set of changes includes the subset of service configuration changes. In an embodiment of the disclosure, the computer system 202 determines the service configuration update of the service configuration associated with the cloud platform 206. The service configuration refers to the settings, and parameters associated with the cloud platform 206. The parameters determine the behavior, operational characteristics, and environment-specific attributes of the cloud platform 206. The update in the service configuration of the cloud platform 206 is determined to determine the utilization of the one or more resources 208A by the application 208. The changes in the application configuration are executed to improve the overall efficiency, performance, and utilization of the one or more resources 208A by the application 208.

By the way of example, and not by limitation, the subset of service configuration changes includes the addition of a service to the cloud platform 206. For example, the cloud platform 206 includes a set of security groups. Each security group of the set of security groups is indicative of a tool that is utilized to control the flow of traffic in the cloud environment of the cloud platform 206. For example, a first security group is added to the set of security groups. Upon the addition of the first security group to the set of security groups, the utilization of the one or more resources 208A by the application 208 is increased. The computer system 202 detects the subset of service configuration changes in the service configuration associated with the cloud platform 206 based on the increase in the utilization of the one or more resources 208A by the application 208.

At 604, the language model application operation is executed. In the language model application operation, the computer system 202 applies the language model 210 to the detected subset of service configuration changes. In an embodiment of the disclosure, the computer system 202 applies the language model 210 to the subset of service configuration changes. The language model 210 analyzes the changes in the service configuration associated with the cloud platform 206. For example, the language model 210 analyzes the change indicative of the addition of the first security group to the set of security groups. Upon the analysis, the computer system 202 determines the increase in the utilization of the one or more resources 208A by the application 208.

At 606, the root cause determination operation is executed. In the third subset of root causes determination operation, the computer system 202 determines the third subset of root causes of the set of root causes 214 based on the application of the language model 210 to the detected subset of service configuration changes. Upon the application of the language model 210 to the subset of service configuration changes, the language model 210 determines the third subset of root causes. The third subset of root causes is indicative of the increase in the running cost of the application 208 based on the service configuration change. The increase in the running cost of the application 208 is due to the addition of the first security group to the set of security groups. The increase in the running cost of the application 208 leads to, by way of example, and not by limitation, the increase in the CPU utilization, the increase in the memory utilization, and the increase in the storage utilization.

At 608, the root cause output operation is executed. In the third subset of root causes output operation, the computer system 202 outputs the third subset of root causes of the set of root causes 214. In an embodiment of the disclosure, the computer system 202 renders the alert indicative of the third subset of root causes on the user device 216. The alert indicative of the third subset of root causes corresponds to an increase in the running cost of the application 208 based on the utilization of the one or more resources 208A by the application 208.

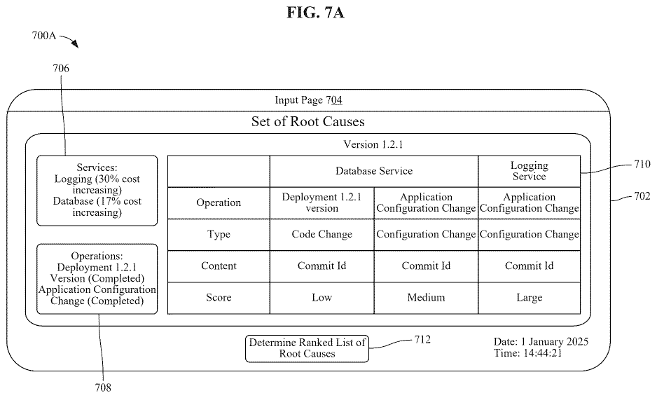

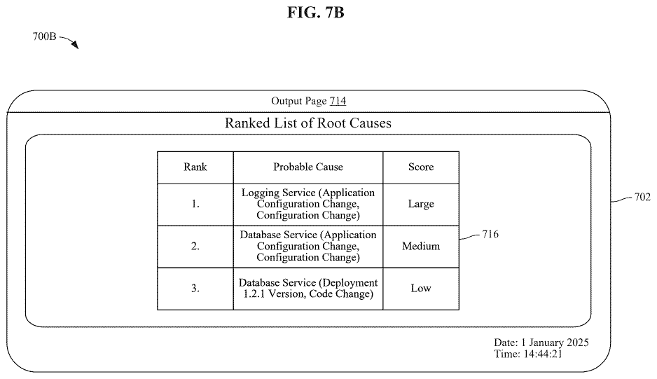

FIG. 7A is a diagram that illustrates an exemplary first user interface for determination of root causes for the increase in running cost of an application, in accordance with an embodiment of the disclosure. FIG. 7A is explained in conjunction with elements from FIG. 1, FIG. 2, FIG. 3, FIG. 4, FIG. 5, and FIG. 6. With reference to FIG. 7A, there is shown an exemplary diagram 700A that includes a user device 702 and an input page 704. The input page 704 includes a first user interface (UI) element 706, a second UI element 708, a first textbox 710, and a third UI element 712. The user device 702 is an exemplary embodiment of the user device 216 of FIG. 2.

With reference to FIG. 7A, the computer system 202 renders the input page 704 on the user interface (UI) of the user device 702. The input page 704 corresponds to a web page or online form that is designed to collect information from an entity or a user who wishes to determine the root causes of the increase in the cost of running the application 208 deployed on the cloud platform 206. In an embodiment of the disclosure, the input page 704 is used to display relevant details associated with the root causes associated with the increase in the cost of running the application 208.

In an exemplary scenario, the computer system 202 detects the set of root causes associated with the increase in the cost of running the application 208. The increase in the cost is associated with utilization of the one or more resources 208A by one or more services of the application 208. By way of example, and not by limitation, the increase in the cost of running the application 208 is associated with the logging service and database service (as shown in the figure). The increase in the cost is associated with the deployment of a new version (1.2.1, as mentioned in the figure), and the change in the application configuration.

In database service, upon the deployment of the version of the application 208, a code change is analyzed and a score is determined. The score is indicative of the severity of the increase in the utilization of the one or more resources 208A by the application 208 associated with the database service. Similarly, the score associated with the increase in the running cost of the application 208 based on the application configuration change in the database service is determined. Similarly, the score associated with the increase in the running cost of the application 208 based on the application configuration change in the logging service is determined.

The first UI element 706 corresponds to a card. The card displays information on the input page 704. The computer system 202 utilizes the first UI element 706 to display information labeled “Services”. The “Services” is indicative of the services associated with the increase in the cost of running the application 208. The second UI element 708 corresponds to the card. The computer system 202 utilizes the second UI element 708 to display information labeled “Operations”. The “Operations” is indicative of the operations that are associated with the application 208 (say deployment of the latest version of the application 208).

The first textbox 710 is rendered as a table. The computer system 202 utilizes the first textbox 710 to display the set of root causes 214 associated with the increase in the cost of running the application 208. The first textbox 710 is divided into a table where the root causes of the set of root causes 214 can be displayed based on the service with which the root cause is associated.

The third UI element 712 corresponds to a button and is labeled as “Determine Ranked List”. Upon selecting the third UI element 712, the computer system 202 utilizes the set of root causes 214 and further initiates the set of scores determination. The computer system 202 determines the set of scores associated with the set of root causes 214. The computer system 202 associates the set of scores with the set of root causes 214. Each score of the set of scores is associated with the corresponding root cause of the set of root causes 214. The computer system 202 further determines a ranked list of root causes based on the association of the set of scores with the set of root causes 214. The ranked list of root causes is indicative of the ordered list of the set of root causes 214. Details about the set of scores, and ranked list determination, are provided, in FIG. 3.

FIG. 7B is a diagram that illustrates an exemplary second user interface for determination of root causes for the increase in running cost of an application, in accordance with an embodiment of the disclosure. FIG. 7B is explained in conjunction with elements from FIG. 1, FIG. 2, FIG. 3, FIG. 4, FIG. 5, FIG. 6, and FIG. 7A. With reference to FIG. 7B, there is shown an exemplary diagram 700B that includes the user device 702 and an output page 714. The output page 714 includes a second textbox 716. The user device 702 is an exemplary embodiment of the user device 216 of FIG. 2.

With reference to FIG. 7B, the computer system 202 renders the output page 714 on the display unit (or the user interface) of the user device 702. The computer system 202 renders the ranked list of root causes on the user device 702. The computer system 202 determines the score of the set of scores associated with the corresponding root cause of the set of root causes 214. By way of example, and not by limitation, the set of scores includes a first score (say 8, high) associated with the first root cause of the set of root causes 214, a second score (say 6, medium) associated with the second root cause of the set of root causes 214, a third score (say 3, low) associated with the third root cause of the set of root causes 214. The ranked list is outputted as the first root cause, the second root cause, and the third root cause in the decreasing order. The decreasing order is associated with the severity of the increase in the utilization of the one or more resources 208A by the application 208. The second textbox 716 corresponds to a textbox that includes the ranked list of root causes. The second textbox 716 is rendered as a table, for example, “Rank: 1, Probable Cause: Logging Service (Application Configuration Change, Configuration Change), and the score: ‘8’ (large), indicating the severity of increase in the cost of running the application”.

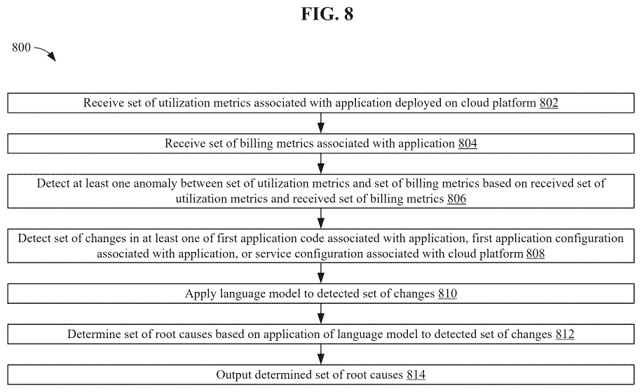

FIG. 8 is a diagram that illustrates a flowchart of an exemplary method for determination of root causes for the increase in running cost of an application, in accordance with an embodiment of the disclosure. FIG. 8 is explained in conjunction with elements from FIG. 1, FIG. 2, FIG. 3, FIG. 4, FIG. 5, FIG. 6, FIG. 7A, and FIG. 7B. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the set of utilization metrics 204A associated with the application 208 deployed on the cloud platform 206 is received. In an embodiment of the disclosure, the computer system 202 receives the set of utilization metrics 204A associated with the application 208 deployed on the cloud platform 206. Details about the set of utilization metrics reception operation are provided, for example, in FIG. 3.

At 804, the set of billing metrics 204B associated with the application 208 is received. In an embodiment of the disclosure, the computer system 202 receives the set of billing metrics 204B associated with the application 208. Details about the set of billing metrics reception operation are provided, for example, in FIG. 2 and FIG. 3.

At 806, the at least one anomaly is detected between the set of utilization metrics 204A and the set of billing metrics 204B based on the received set of utilization metrics 204A and the received set of billing metrics 204B. In an embodiment of the disclosure, the computer system 202 detects the at least one anomaly between the set of utilization metrics 204A and the set of billing metrics 204B based on the received set of utilization metrics 204A and the received set of billing metrics 204B. Details about the at least anomaly detection are provided, for example, in FIG. 3.

At 808, the set of changes is detected in at least one of the application code associated with the application 208, the application configuration associated with the application 208, or the service configuration associated with the cloud platform 206. In an embodiment of the disclosure, the computer system 202 detects the set of changes in at least one of the first application code associated with the application 208, the first application configuration associated with the application 208, or the service configuration associated with the cloud platform 206. Details about the set of changes detection operation are provided, for example, in FIG. 3.

At 810, the language model 210 is applied to the detected set of changes. In an embodiment of the disclosure, the computer system 202 applies the language model 210 to the detected set of changes. Details about the language model application operation on the set of changes are provided, for example, in FIG. 3.

At 812, the set of root causes 214 is determined based on the application of the language model 210 to the detected set of changes. In an embodiment of the disclosure, the computer system 202 determines the set of root causes 214 based on the application of the language model 210 to the detected set of changes. Details about the set of root causes determination operation are provided, for example, in FIG. 3.

At 814, the determined set of root causes 214 is outputted. In an embodiment of the disclosure, the computer system 202 outputs the determined set of root causes 214. Details about the outputting of the set of root causes 214 are provided in, for example, FIG. 3.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
receiving, by a computer, a set of utilization metrics associated with an application deployed on a cloud platform, wherein the set of utilization metrics is indicative of a utilization of one or more resources by the application;
receiving, by the computer, a set of billing metrics associated with the application;
detecting, by the computer, at least one anomaly between the set of utilization metrics and the set of billing metrics based on the received set of utilization metrics and the received set of billing metrics;
detecting, by the computer, a set of changes in at least one of a first application code associated with the application, a first application configuration associated with the application, or a service configuration associated with the cloud platform, wherein the set of changes are detected based on the at least one anomaly;
applying, by the computer, a language model to the detected set of changes;
determining, by the computer, a set of root causes associated with the utilization of the one or more resources by the application, wherein the set of root causes is determined based on the application of the language model to the detected set of changes; and
outputting, by the computer, the determined set of root causes.

2. The computer-implemented method of claim 1, further comprising:
applying, by the computer, a machine learning (ML) model to the set of utilization metrics and the set of billing metrics; and
detecting, by the computer, the at least one anomaly based on the application of the ML model to the set of utilization metrics and the set of billing metrics.

3. The computer-implemented method of claim 1, further comprising:
determining, by the computer, an application code update of the first application code to a second application code;
detecting, by the computer, a subset of application code changes in the first application code based on the determination of the application code update, wherein the set of changes comprises the subset of application code changes;
applying, by the computer, the language model to the detected subset of application code changes;
determining, by the computer, a first subset of root causes of the set of root causes based on the application of the language model to the detected subset of application code changes; and
outputting, by the computer, the first subset of root causes.

4. The computer-implemented method of claim 3, further comprising:
comparing, by the computer, the first application code with the second application code, wherein the first application code is associated with a first version of the application and the second application code is associated with a second version of the application; and
detecting, by the computer, the subset of application code changes in the first application code based on the comparison.

5. The computer-implemented method of claim 1, further comprising:
determining, by the computer, an application configuration update of the first application configuration to a second application configuration;
detecting, by the computer, a subset of application configuration changes in the first application configuration based on the determination of the application configuration update, wherein the set of changes comprises the subset of application configuration changes;
applying, by the computer, the language model to the detected subset of application configuration changes;
determining, by the computer, a second subset of root causes of the set of root causes based on the application of the language model to the detected subset of application configuration changes; and
outputting, by the computer, the second subset of root causes.

6. The computer-implemented method of claim 5, further comprising:
comparing, by the computer, the first application configuration with the second application configuration, wherein the first application configuration is associated with a first version of the application and the second application configuration is associated with a second version of the application; and
detecting, by the computer, the subset of application configuration changes in the first application configuration based on the comparison.

7. The computer-implemented method of claim 1, further comprising:
detecting, by the computer, a subset of service configuration changes in the service configuration associated with the cloud platform, wherein the set of changes comprises the subset of service configuration changes;
applying, by the computer, the language model to the detected subset of service configuration changes;
determining, by the computer, a third subset of root causes of the set of root causes based on the application of the language model to the detected subset of service configuration changes; and
outputting, by the computer, the third subset of root causes.

8. The computer-implemented method of claim 1, further comprising:
determining, by the computer, a set of scores based on the determined set of root causes;
associating, by the computer, the set of scores with the determined set of root causes;
determining, by the computer, a ranked list of root causes based on the association of the set of scores with the determined set of root causes; and
outputting, by the computer, the determined ranked list of root causes.

9. The computer-implemented method of claim 1, wherein the application is associated with one or more services, and wherein the determined set of root causes is associated with the utilization of the one or more resources by at least one service of the one or more services.

10. A computer system, comprising:
a processor set;
one or more computer-readable storage media; and
program instructions stored on the one or more computer-readable storage media, the program instructions executable by the processor set to cause the processor set to:
receive a set of utilization metrics associated with an application deployed on a cloud platform, wherein the set of utilization metrics is indicative of a utilization of one or more resources by the application;
receive a set of billing metrics associated with the application;
detect at least one anomaly between the set of utilization metrics and the set of billing metrics based on the received set of utilization metrics and the received set of billing metrics;
detect a set of changes in at least one of a first application code associated with the application, a first application configuration associated with the application, or a service configuration associated with the cloud platform, wherein the set of changes are detected based on the at least one anomaly;
apply a language model to the detected set of changes;
determine a set of root causes associated with the utilization of the one or more resources by the application, wherein the set of root causes is determined based on the application of the language model to the detected set of changes; and
output the determined set of root causes.

11. The computer system of claim 10, wherein the program instructions further cause the processor set to:
apply a machine learning (ML) model to the set of utilization metrics and the set of billing metrics; and
detect the at least one anomaly based on the application of the ML model to the set of utilization metrics and the set of billing metrics.

12. The computer system of claim 10, wherein the program instructions further cause the processor set to:
determine an application code update of the first application code to a second application code;
detect a subset of application code changes in the first application code based on the determination of the application code update, wherein the set of changes comprises the subset of application code changes;
apply the language model to the detected subset of application code changes;
determine a first subset of root causes of the set of root causes based on the application of the language model to the detected subset of application code changes; and
output the first subset of root causes.

13. The computer system of claim 12, wherein the program instructions further cause the processor set to:
compare the first application code with the second application code, wherein the first application code is associated with a first version of the application, and the second application code is associated with a second version of the application; and
detect the subset of application code changes in the first application code based on the comparison.

14. The computer system of claim 10, wherein the program instructions further cause the processor set to:
determine an application configuration update of the first application configuration to a second application configuration;
detect a subset of application configuration changes in the first application configuration based on the determination of the application configuration update, wherein the set of changes comprises the subset of application configuration changes;
apply the language model to the detected subset of application configuration changes;
determine a second subset of root causes of the set of root causes based on the application of the language model to the detected subset of application configuration changes; and
output the second subset of root causes.

15. The computer system of claim 14, wherein the program instructions further cause the processor set to:
compare the first application configuration with the second application configuration, wherein the first application configuration is associated with a first version of the application, and the second application configuration is associated with a second version of the application; and
detect the subset of application configuration changes in the first application configuration based on the comparison.

16. The computer system of claim 10, wherein the program instructions further cause the processor set to:
detect a subset of service configuration changes in the service configuration associated with the cloud platform, wherein the set of changes comprises the subset of service configuration changes;
apply the language model to the detected subset of service configuration changes;
determine a third subset of root causes of the set of root causes based on the application of the language model to the detected subset of service configuration changes; and
output the third subset of root causes.

17. The computer system of claim 10, wherein the program instructions further cause the processor set to:
determine a set of scores based on the determined set of root causes;
associate the set of scores with the determined set of root causes;
determine a ranked list of root causes based on the association of the set of scores with the determined set of root causes; and
output the determined ranked list of root causes, wherein the application is associated with one or more services, and wherein the determined ranked list of root causes is associated with the utilization of the one or more resources by at least one service of the one or more services.

18. A computer-program product for determination of a set of root causes associated with an application, the computer-program product comprising:
one or more computer-readable storage media; and
program instructions stored on the one or more computer-readable storage media to perform operations comprising:
receiving a set of utilization metrics associated with the application deployed on a cloud platform, wherein the set of utilization metrics is indicative of a utilization of one or more resources by the application;
receiving a set of billing metrics associated with the application;
detecting at least one anomaly between the set of utilization metrics and the set of billing metrics based on the received set of utilization metrics and the received set of billing metrics;
detecting a set of changes in at least one of a first application code associated with the application, a first application configuration associated with the application, or a service configuration associated with the cloud platform, wherein the set of changes are detected based on the at least one anomaly;
applying a language model to the detected set of changes;
determining the set of root causes associated with the utilization of the one or more resources by the application, wherein the set of root causes is determined based on the application of the language model to the detected set of changes; and
outputting the determined set of root causes.

19. The computer-program product of claim 18, wherein the program instructions stored on the one or more computer-readable storage media perform the operations further comprising:
applying a machine learning (ML) model to the set of utilization metrics and the set of billing metrics; and
detecting the at least one anomaly based on the application of the ML model to the set of utilization metrics and the set of billing metrics.

20. The computer-program product of claim 18, wherein the application is associated with one or more services, and wherein the determined set of root causes is associated with the utilization of the one or more resources by at least one service of the one or more services.
